(19) United States
(12) Patent Application Publication
(10) Pub. No.: US 2024/0363271 A1
(43) Pub. Date: Oct. 31, 2024

(54) R-T-B BASED PERMANENT MAGNET AND METHOD OF MANUFACTURING THE SAME

(71) Applicant: TDK Corporation, Tokyo (JP)

(72) Inventors: Hiroki KAWAMURA, Tokyo (JP); Hikaru KUDO, Tokyo (JP); Motohisa NOMI, Tokyo (JP)

(73) Assignee: TDK Corporation, Tokyo (JP)

(21) Appl. No.: 18/645,505

(22) Filed: Apr. 25, 2024

(30) Foreign Application Priority Data
Apr. 27, 2023 (JP) 2023-073518
Feb. 22, 2024 (JP) 2024-025671

(51) Int. Cl. H01F 1/057; B22F 3/16; B22F 3/24; B22F 9/02; B22F 9/04; C22C 33/02; C22C 38/00; C22C 38/06; C22C 38/10; C22C 38/14; C22C 38/16

(52) U.S. Cl. CPC H01F 1/0577; B22F 3/16; B22F 3/24; B22F 9/023; B22F 9/04; C22C 33/0207; C22C 33/0278; C22C 38/002; C22C 38/005; C22C 38/06; C22C 38/10; C22C 38/14; C22C 38/16; B22F 2003/248; B22F 2009/044; B22F 2201/11; B22F 2201/20; B22F 2202/05; B22F 2301/355; B22F 2304/10; B22F 2998/10; B22F 2999/00; C22C 2202/02

(57) ABSTRACT

An R-T-B based permanent magnet includes C and Zr. The R-T-B based permanent magnet includes a main phase grain and a grain boundary. The R-T-B based permanent magnet has Zr concentration distribution of the main phase grain within a specific range, and a S(C)/(S(B)+S(C)) of 98.0% or more, where S(B) denotes a total area of ZrB₂ in the grain boundary and S(C) denotes a total area of ZrC in the grain boundary, in a section of the R-T-B based permanent magnet. The R-T-B based permanent magnet has a Zr content of 0.60 mass % or more and 1.60 mass % or less, a B content of above 0 mass % and 0.85 mass % or less, and a C content of above 0 mass % and 0.260 mass % or less, out of 100 mass % of the R-T-B based permanent magnet.

### TECHNICAL FIELD

The present disclosure relates to an R-T-B based permanent magnet and a method of manufacturing the same.

### BACKGROUND

Patent Document 1 describes an invention related to an R-T-B based rare earth element permanent magnet and the like. In a method of manufacturing the R-T-B based rare earth element permanent magnet described in Patent Document 1, low R alloys containing an R₂T₁₄B phase as a main phase and high R alloys containing a higher amount of R than the low R alloys are used.
Patent Document 1: WO 2004/029997

### SUMMARY

It is an object of the present disclosure to provide an R-T-B based permanent magnet having an improved residual magnetic flux density (Br), an improved coercivity (HcJ), and an improved squareness ratio (Hk/HcJ).

An R-T-B based permanent magnet according to a first aspect of the present disclosure is
an R-T-B based permanent magnet including C and Zr, wherein
the R-T-B based permanent magnet includes a main phase grain and a grain boundary;
the R-T-B based permanent magnet has
   a [Zr1] of 0 or more and 0.35 at % or less, where [Zr1] denotes a Zr concentration of a center portion of the main phase grain, and a S(C)/(S(B)+S(C)) of 98.0% or more, where S(B) denotes a total area of ZrB₂ in the grain boundary and S(C) denotes a total area of ZrC in the grain boundary,
   in a section of the R-T-B based permanent magnet; and
the R-T-B based permanent magnet has
   a Zr content of 0.60 mass % or more and 1.60 mass % or less,
   a B content of above 0 mass % and 0.85 mass % or less, and
   a C content of above 0 mass % and 0.260 mass % or less,
   out of 100 mass % of the R-T-B based permanent magnet.

An R-T-B based permanent magnet according to a second aspect of the present disclosure is
an R-T-B based permanent magnet including C and Zr, wherein
the R-T-B based permanent magnet includes a main phase grain and a grain boundary;
the R-T-B based permanent magnet has
   a [Zr1]/[Zr2] of 0.70 or more and 1.20 or less in atomic ratio, where [Zr1] denotes a Zr concentration of a center portion of the main phase grain and [Zr2] denotes a Zr concentration of a peripheral portion of the main phase grain, and a S(C)/(S(B)+S(C)) of 98.0% or more, where S(B) denotes a total area of ZrB₂ in the grain boundary and S(C) denotes a total area of ZrC in the grain boundary,
   in a section of the R-T-B based permanent magnet; and
the R-T-B based permanent magnet has
   a Zr content of 0.60 mass % or more and 1.60 mass % or less,
   a B content of above 0 mass % and 0.85 mass % or less, and
   a C content of above 0 mass % and 0.260 mass % or less,
   out of 100 mass % of the R-T-B based permanent magnet.

The following is common to the first aspect and the second aspect.

A total area percentage of ZrB₂ in the section of the R-T-B based permanent magnet may be 0% or more and less than 0.01%.

ZrB₂ may have a maximum grain size of 1.0 μm or less, and ZrC may have a maximum grain size of 1.0 μm or less.

The R-T-B based permanent magnet may have a heavy rare earth element content of 0 mass % or more and 0.80 mass % or less.

The R-T-B based permanent magnet may further include Ga and have a Ga content of 0.40 mass % or more and 1.00 mass % or less.

The R-T-B based permanent magnet may further include Al and have an Al content of above 0 mass % and 0.07 mass % or less.

The R-T-B based permanent magnet may have a rare earth element content of 29.00 mass % or more and 34.00 mass % or less.

The R-T-B based permanent magnet may have a rare earth element content of 30.00 mass % or more and 33.00 mass % or less and a B content of 0.70 mass % or more and 0.85 mass % or less.

A method of manufacturing an R-T-B based permanent magnet, according to a third aspect of the present disclosure, includes
preparing a main alloy and a sub alloy; and
mixing the main alloy and sub alloy,
wherein
the main alloy has a C content of 0.070 mass % or more and 0.180 mass % or less;
the sub alloy has a Zr content of 3.00 mass % or more and 7.00 mass % or less; and
the main alloy and the sub alloy are mixed at a ratio of 85:15 to 92:8 based on mass.

The main alloy may have
a rare earth element content of 30.00 mass % or more and 32.50 mass % or less,
an Al content of 0 mass % or more and 0.10 mass % or less,
a Ga content of 0.40 mass % or more and 1.20 mass % or less,
a Cu content of 0.10 mass % or more and 1.00 mass % or less,
a Co content of 0.50 mass % or more and 3.00 mass % or less,
a Zr content of 0.10 mass % or more and 0.80 mass % or less, and
a B content of 0.70 mass % or more and 1.00 mass % or less; and
the sub alloy may have
a rare earth element content of 30.00 mass % or more and 45.00 mass % or less,
an Al content of 0 mass % or more and 1.00 mass % or less,
a Ga content of 0 mass % or more and 8.00 mass % or less,
a Cu content of 0 mass % or more and 5.00 mass % or less, and
a Co content of 0 mass % or more and 10.00 mass % or less.

An area percentage of a 6-13-1 phase in a section of the main alloy may be 0% or more and less than 2.0%.

The method may further include sintering a green compact for a sintering time of 2 hours or more and 8 hours or less.

The R-T-B based permanent magnet may have
a rare earth element content of 30.00 mass % or more and 33.00 mass % or less,
a B content of 0.70 mass % or more and 0.88 mass % or less,
an Al content of above 0 mass % and 0.07 mass % or less,
a Ga content of 0.40 mass % or more and 1.00 mass % or less, and
a Zr content of above 0.10 mass % and 1.60 mass % or less.

### BRIEF DESCRIPTION OF THE DRAWING(S)

FIG. 1 is an elemental mapping image of Sample No. 3.

FIG. 2 is an elemental mapping image of Sample No. 10.

FIG. 3 is an enlarged view of a main part of FIG. 1.

FIG. 4 is an enlarged view of a main part of FIG. 2.

FIG. 5 is a SEM image of Sample No. 3.

FIG. 6 is a SEM image of Sample No. 3.

### DETAILED DESCRIPTION

Hereinafter, the present disclosure is described based on embodiments.

### First Embodiment

An R-T-B based permanent magnet includes main phase grains including crystal grains having an R₂T₁₄B type crystal structure. The R-T-B based permanent magnet further includes grain boundaries each provided between two or more of the main phase grains adjacent to each other.

In the R-T-B based permanent magnet and the R₂T₁₄B type crystal structure, “R” represents a rare earth element, “T” represents a transition metal element, and “B” represents boron.

At least one rare earth element contained as “R” in the R-T-B based permanent magnet and the R₂T₁₄B type crystal structure may include Sc, Y, or lanthanoid. At least one transition metal element contained as “T” does not include rare earth elements. The at least one transition metal element contained as “T” may include at least one iron group element. The at least one iron group element contained as “T” may include only Fe. Fe contained as “T” may be partly substituted by Co. Boron contained as “B” may be partly substituted by carbon.

In the present embodiment, rare earth elements are classified into heavy rare earth elements and light rare earth elements. Heavy rare earth elements include Gd, Tb, Dy, Ho, Er, Tm, Yb, and Lu. Light rare earth elements include rare earth elements other than heavy rare earth elements. Iron group elements include Fe, Co, and Ni.

The R-T-B based permanent magnet according to the present embodiment contains carbon (C) and zirconium (Zr). The R-T-B based permanent magnet has a microstructure and a composition described below.

### (Microstructure)

The R-T-B based permanent magnet includes a main phase grain and a grain boundary; and has
a [Zr1] of 0 or more and 0.35 at % or less, where [Zr1] denotes a Zr concentration of a center portion of the main phase grain, and
a S(C)/(S(B)+S(C)) of 98.0% or more, where S(B) denotes a total area of ZrB₂ in the grain boundary and S(C) denotes a total area of ZrC in the grain boundary,
in a section of the R-T-B based permanent magnet.

A low Zr concentration of the center portion of the main phase grain of the R-T-B based permanent magnet and a high ratio of ZrC to a total of ZrB₂ and ZrC among Zr compounds contained in the grain boundary of the R-T-B based permanent magnet enable the R-T-B based permanent magnet to have suitable Br, HcJ, and Hk/HcJ. In particular, even when the R-T-B based permanent magnet has a relatively low heavy rare earth element content, has a relatively low B content, and/or has a relatively short sintering time, the R-T-B based permanent magnet can have suitable Br, HcJ, and Hk/HcJ.

When [Zr1] is too high, HcJ and Hk/HcJ decrease. When S(C)/(S(B)+S(C)) is too low, Br and Hk/HcJ decrease, and further HcJ tends to decrease.

[Zr2] may be 0 or more and 0.72 at % or less, where [Zr2] denotes a Zr concentration of a peripheral portion of the main phase grain.

A total area percentage of ZrB₂ in a section of the R-T-B based permanent magnet may be 0% or more and less than 0.01%. With the above range of the total area percentage of ZrB₂, the R-T-B based permanent magnet tends to have good Hk/HcJ.

At least 99% of Zr compounds based on the number of Zr compounds in a section of the R-T-B based permanent magnet may have a grain size of 1.0 μm or less. The ratio of the total number of ZrB₂ having a grain size of 1.0 μm or less and ZrC having a grain size of 1.0 μm or less to the total number of ZrB₂ and ZrC may be 99% or more. The Zr compounds may have a maximum grain size of 1.0 μm or less. ZrB₂ may have a maximum grain size of 1.0 μm or less, and ZrC may have a maximum grain size of 1.0 μm or less.

A method of measuring [Zr1] and [Zr2] of the main phase grain included in the R-T-B based permanent magnet is described below.

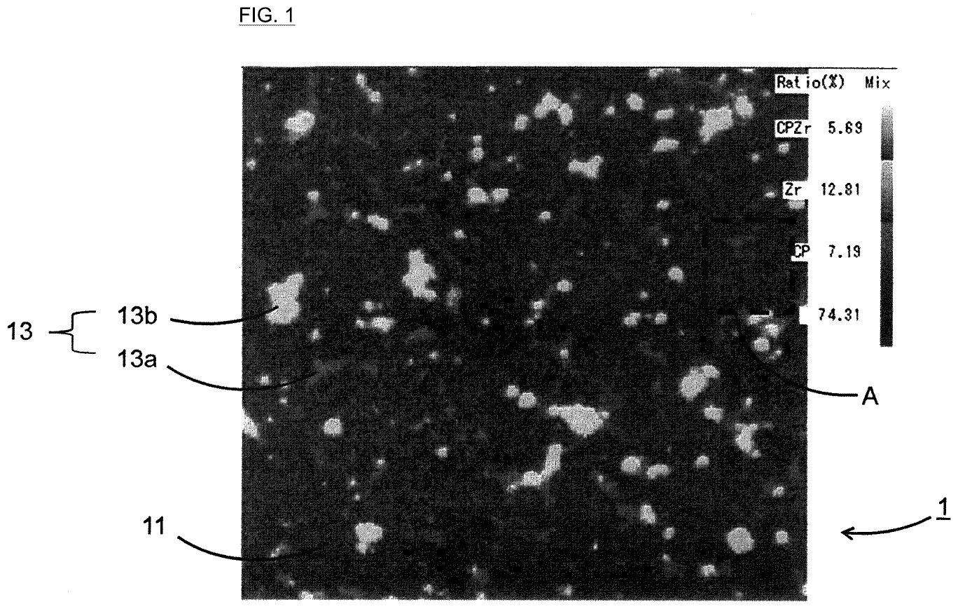

First, elemental mapping of a section of the R-T-B based permanent magnet is performed. An apparatus for performing elemental mapping is not limited and may be any apparatus with which elemental mapping can be appropriately performed. For example, an EPMA or EDS may be used. The magnification may be any magnification at which [Zr1] and [Zr2] can be appropriately measured. For example, the magnification may be 1500× or more and 10000× or less. Elemental mapping gives an image shown as, for example, FIG. 1.

An R-T-B based permanent magnet 1 shown in FIG. 1 is a Sample No. 3 example described later. The R-T-B based permanent magnet 1 includes a main phase grain 11 and a grain boundary 13. The grain boundary 13 includes an R-containing portion 13a and a Zr-containing portion 13b.

The R-containing portion 13a is a portion particularly rich in an R-rich phase and/or a 6-13-1 phase in the grain boundary 13. The R-rich phase is a phase that is richer in at least “R” and Co, Cu, and/or Ga than the main phase grain 11. The 6-13-1 phase is a phase that is rich in “R”, Fe, Co, Cu, and Ga.

The Zr-containing portion 13b is a portion particularly rich in Zr compounds in the grain boundary 13.

The grain boundary 13 may include a portion that is difficult to be identified as the R-containing portion 13a or the Zr-containing portion 13b for being rich in both “R”, Co, Cu, and/or Ga and Zr.

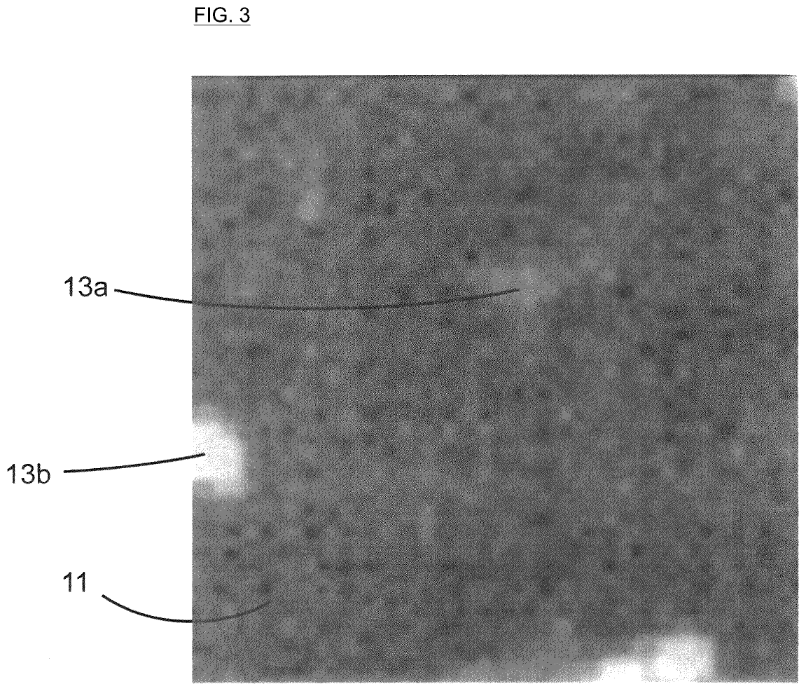

The location and the shape of the main phase grain 11 included in the resulting elemental mapping image are identified. At this time, the elemental mapping image may be enlarged as appropriate. For example, FIG. 3 is an enlarged image of a part A of FIG. 1. Then, a center portion of the main phase grain 11 included in its entirety in the elemental mapping image is identified. Specifically, a portion of the main phase grain 11 in the elemental mapping image apart from a surface of the main phase grain 11 by a distance of 40% or more of the equivalent circle diameter of that main phase grain is defined as the center portion of the main phase grain 11. In other words, the center portion is where the distance from a border between the main phase grain 11 and the grain boundary 13 is 40% or more of the equivalent circle diameter of that main phase grain. The Zr concentration of the center portion of the main phase grain 11 is measured and is defined as [Zr1]. Note that a target main phase grain whose [Zr1] and [Zr2] are measured is a main phase grain 11 having a region satisfying the definition of the center portion and a region satisfying the definition of the peripheral portion described later.

When [Zr1] of the R-T-B based permanent magnet 1 is calculated, the elemental mapping image is observed so that the number of main phase grains 11 being included in their entirety in the image and each having the center portion is at least three. The number of main phase grains 11 being included in their entirety in the image and each having the center portion may be five or more. [Zr1] of the R-T-B based permanent magnet 1 may be calculated by measuring [Zr1] of each of the main phase grains 11 included in their entirety in the elemental mapping image and averaging the measurement.

A method of measuring [Zr2] is the same as the method of measuring [Zr1] except that a portion subject to Zr concentration measurement is changed from the center portion of the main phase grain 11 to the peripheral portion of the main phase grain 11. Specifically, the peripheral portion of the main phase grain 11 is a portion apart from the surface of the main phase grain 11 in the elemental mapping image by a distance of 30% or less of the equivalent circle diameter of that main phase grain. In other words, the peripheral portion is located where the distance from the border between the main phase grain 11 and the grain boundary 13 is 30% or less of the equivalent circle diameter of that main phase grain. In order not to detect a grain boundary component in measurement of [Zr2], a portion apart from the surface of the main phase grain 11 by a distance of 15% or more and 30% or less of the equivalent circle diameter of that main phase grain may be subject to measurement.

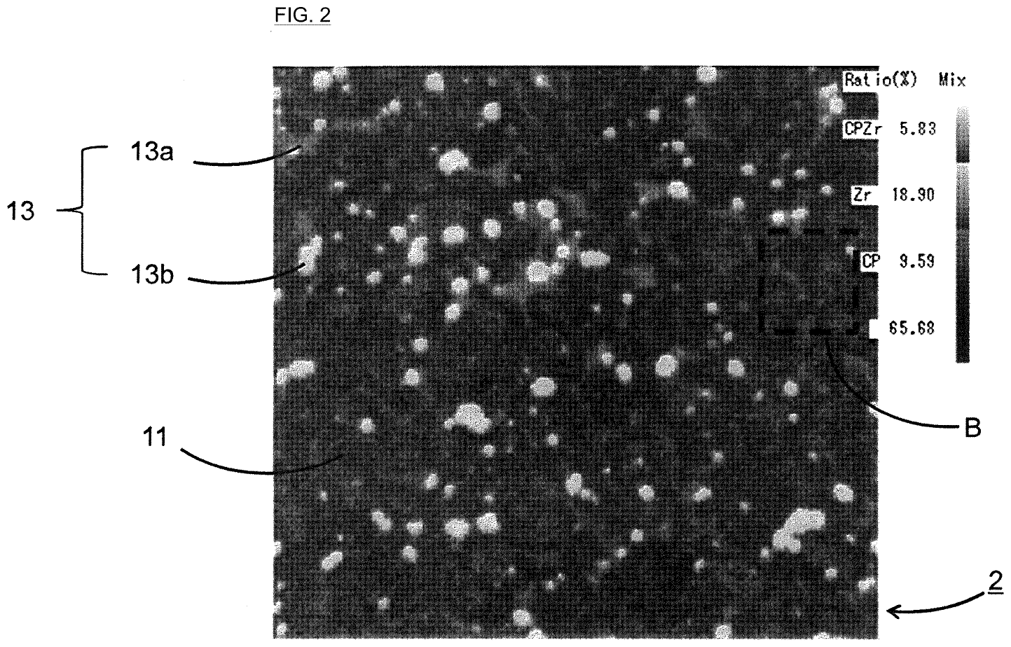

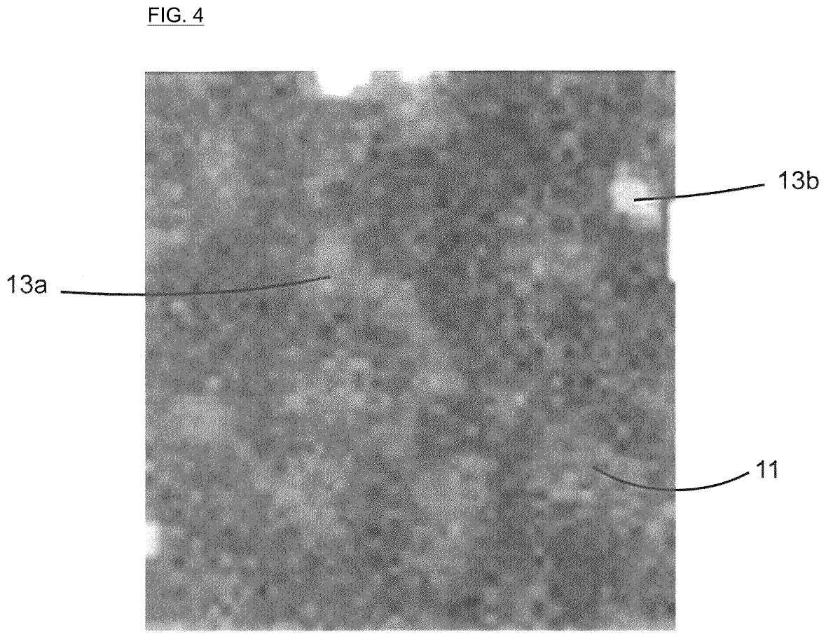

An R-T-B based permanent magnet 2 shown in FIG. 2 is a Sample No. 10 comparative example described later. FIG. 4 is an enlarged image of a part B of FIG. 2. According to FIGS. 2 and 4, the R-T-B based permanent magnet 2 shown in FIG. 2 has a higher Zr concentration of the main phase grain 11 than the R-T-B based permanent magnet 1 shown in FIG. 1. In particular, it seems that the Zr concentration of the center portion of the main phase grain 11 is high and that, according to Zr concentration distribution, the main phase grain 11 is a core-shell grain including a shell with a low Zr concentration and a core with a high Zr concentration. That is, because [Zr1] of the R-T-B based permanent magnet 2 is too high, the R-T-B based permanent magnet 2 has low HcJ and low Hk/HcJ.

A method of observing the Zr compounds and a method of distinguishing between ZrB₂ and ZrC are described below. Additionally, a method of measuring S(C)/(S(B)+S(C)) and a method of measuring the grain sizes of the Zr compounds are described.

First, a compositional image of a section of the R-T-B based permanent magnet is observed. An apparatus for observing the compositional image is not limited and may be any apparatus with which the compositional image can be appropriately observed. For example, a SEM may be used. The magnification may be any magnification at which the Zr compounds can be appropriately observed. For example, the magnification may be 2500× or more and 20000× or less.

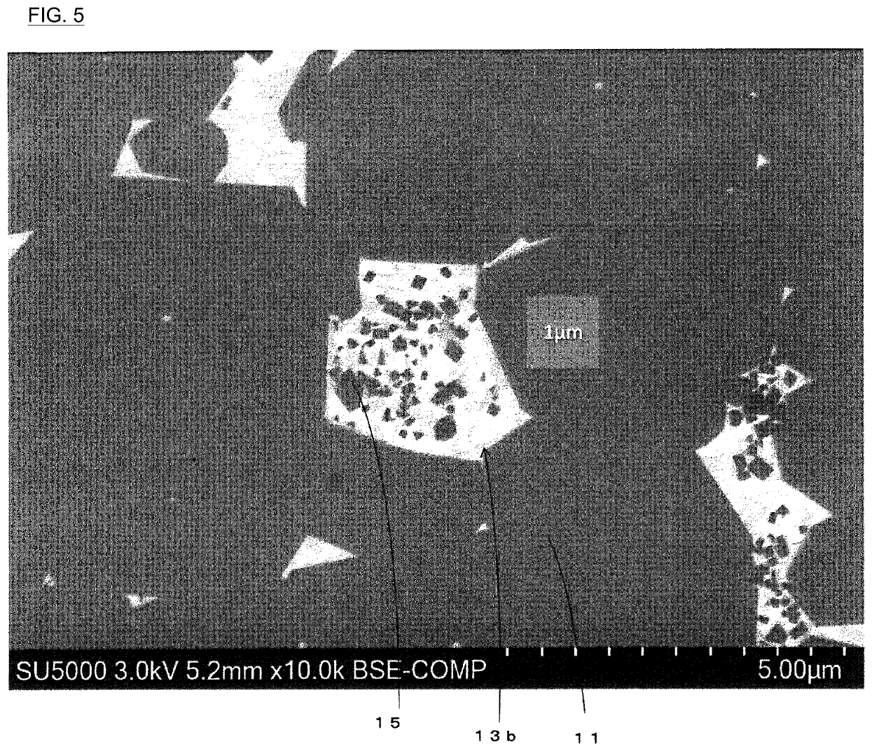

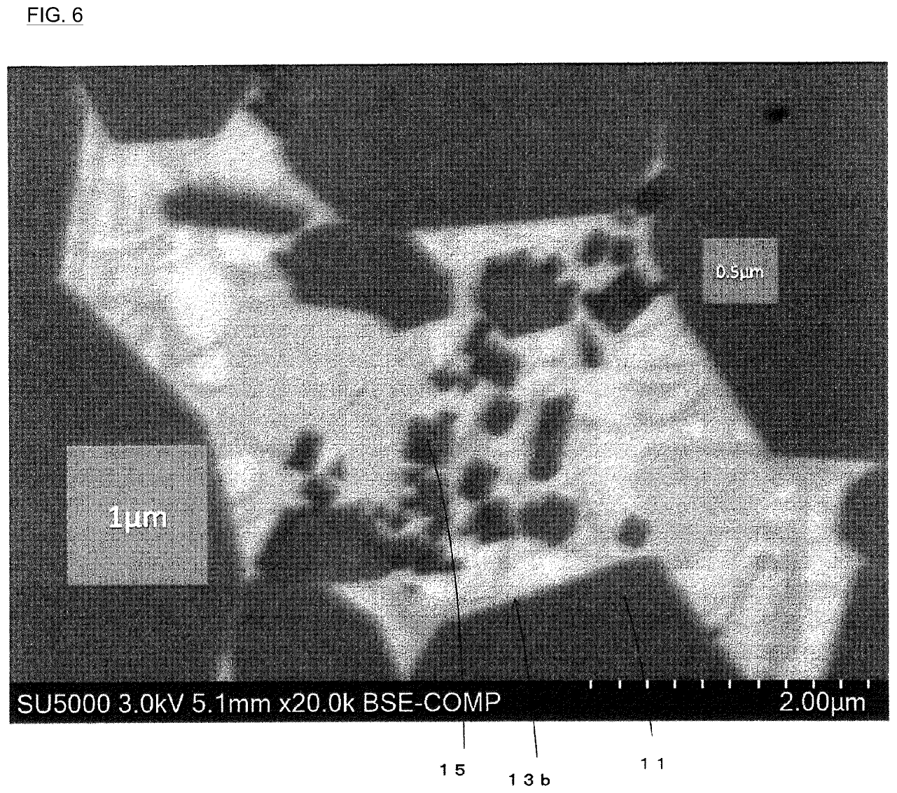

FIG. 5 is a SEM image of a section of the R-T-B based permanent magnet 1 observed at a magnification of 10000× using a SEM. FIG. 6 is a SEM image of a part, different from that of FIG. 5, of the section of the R-T-B based permanent magnet 1 observed at a magnification of 20000× using a SEM. In FIG. 5, a square having 1-μm long sides is drawn as a comparison target. In FIG. 6, a square having 1-μm long sides and a square having 0.5-μm long sides are drawn as comparison targets.

FIGS. 5 and 6 mainly show the main phase grain 11 and the Zr-containing portion 13b, which is rich in the Zr compounds in the grain boundary 13. The Zr-containing portion 13b contains Zr compounds 15. In the Zr-containing portion 13b, the Zr compounds 15 and other portions can be distinguished using difference in contrast.

Whether the Zr compounds 15 are ZrB₂ or ZrC can be determined from the shapes of the Zr compounds 15 in the SEM images of the section of the R-T-B based permanent magnet 1. Specifically, whether the Zr compounds 15 are ZrB₂ or ZrC can be determined from the aspect ratios (major axis/minor axis) of the Zr compounds 15. It can be determined that a Zr compound having an aspect ratio of above 5 is ZrB₂ and that a Zr compound having an aspect ratio of 5 or less is ZrC. Note that all Zr compounds 15 shown in FIGS. 5 and 6 are ZrC.

Possibility that the SEM images include ZrC having an aspect ratio of above 5 and/or ZrB₂ having an aspect ratio of 5 or less cannot be completely denied. However, in calculation of the total area percentage of ZrB₂ in the R-T-B based permanent magnet and S(C)/(S(B)+S(C)), the above possibility can be ignored.

ZrB₂ has an AlB₂ based hexagonal crystal structure. In a SEM image, ZrB₂ has a needle-like shape. Thus, ZrB₂ looks as though it has an elongated, substantially rectangular shape. ZrC has a face-centered cubic structure. In a SEM image, ZrC has a particulate shape. Thus, ZrC looks as though it has a substantially rectangular shape.

A field of view observed using the SEM is as large as to include at least five Zr compounds 15. The field of view observed using the SEM may be as large as to include ten or more Zr compounds 15. Then, the total area of ZrB₂ denoted by S(B) and the total area of ZrC denoted by S(C) are measured, and S(C)/(S(B)+S(C)) is calculated. Equivalent circle diameters of the Zr compounds are used as their grain sizes.

### (Composition)

As described above, the R-T-B based permanent magnet contains carbon (C) and zirconium (Zr).

Out of 100 mass % of the R-T-B based permanent magnet, the R-T-B based permanent magnet has a Zr content of 0.60 mass % or more and 1.60 mass % or less. The Zr content may be 0.80 mass % or more and 1.20 mass % or less. The lower the Zr content, the more easily abnormal growth of the main phase grains occurs, which tends to decrease HcJ and Hk/HcJ. The higher the Zr content, the more easily a ZrB₂ compound is generated at the time of manufacture of the R-T-B based permanent magnet, easily decreasing S(C)/(S (B)+S(C)). Further, HcJ and Hk/HcJ tend to decrease.

Out of 100 mass % of the R-T-B based permanent magnet, the R-T-B based permanent magnet has a C content of above 0 mass % and 0.260 mass % or less. The C content may be 0.150 mass % or more, 0.160 mass % or more, 0.167 mass % or more, 0.175 mass % or more, 0.200 mass % or more, or 0.226 mass % or more. The C content may be 0.248 mass % or less. The lower the C content, the less easily a ZrC compound is generated at the time of manufacture of the R-T-B based permanent magnet, and the more easily a ZrB₂ compound is generated at that time. Further, S(C)/(S(B)+S(C)) tends to decrease. Moreover, Br, HcJ, and Hk/HcJ tend to decrease. The higher the C content, the more easily HcJ decreases.

Out of 100 mass % of the R-T-B based permanent magnet, the R-T-B based permanent magnet has a B content of above 0 mass % and 0.85 mass % or less. The B content may be 0.70 mass % or more and 0.83 mass % or less. The lower the B content, the more easily sintering tends to be insufficient. As a result, Br and HcJ tend to decrease. The higher the B content, the more easily HcJ decreases.

The R-T-B based permanent magnet may have any rare earth element content (TRE). For example, the rare earth element content may be 29.00 mass % or more and 34.00 mass % or less or may be 30.00 mass % or more and 33.00 mass % or less. The lower the TRE, the more easily HcJ decreases. The higher the TRE, the more easily abnormal grain growth occurs, easily decreasing Br.

The R-T-B based permanent magnet may substantially contain only at least one selected from the group consisting of Nd, Pr, Dy, and Tb as the at least one rare earth element or may substantially contain only at least one selected from the group consisting of Nd and Pr as the at least one rare earth element. The phrase “substantially contain only at least one selected from the group consisting of Nd, Pr, Dy, and Tb as the at least one rare earth element” means that the content of rare earth elements other than Nd, Pr, Dy, and Tb of the R-T-B based permanent magnet is 0.01 mass % or less in total. The phrase “substantially contain only at least one selected from the group consisting of Nd and Pr as the at least one rare earth element” means that the content of rare earth elements other than Nd and Pr of the R-T-B based permanent magnet is 0.01 mass % or less in total.

The R-T-B based permanent magnet may have any heavy rare earth element content. For example, the heavy rare earth element content may be 0 mass % or more and 0.80 mass % or less, 0 mass % or more and 0.50 mass % or less, or 0 mass % or more and 0.30 mass % or less. The higher the heavy rare earth element content, the more easily Br decreases and the more easily raw material costs increase.

The R-T-B based permanent magnet may have any iron group element content and any Co content. In terms of improving magnetic properties and corrosion resistance, the Co content may be 0.50 mass % or more and 3.00 mass % or less or may be 0.80 mass % or more and 3.00 mass % or less. The R-T-B based permanent magnet may substantially not contain Ni. Specifically, the Ni content may be 0 mass % or more and less than 0.01 mass %.

The R-T-B based permanent magnet may further contain Ga, Al, and/or Cu.

The Ga content is not limited. The Ga content may be, for example, 0.40 mass % or more and 1.00 mass % or less. The lower the Ga content, the more easily HcJ decreases. The higher the Ga content, the more easily Br decreases.

The Al content is not limited. The Al content may be, for example, above 0 mass % and 0.07 mass % or less, or 0.02 mass % or more and 0.07 mass % or less. The lower the Al content, the more easily HcJ decreases. The higher the Al content, the more easily Br decreases.

The Cu content is not limited. The Cu content may be, for example, 0 mass % or more and 1.00 mass % or less, or 0.15 mass % or more and 1.00 mass % or less. The lower the Cu content, the more easily Br decreases. The higher the Cu content, the more easily HcJ decreases.

“Out of 100 mass % of the R-T-B based permanent magnet” indicates that the total content of all elements is 100 mass %. The Fe content of the R-T-B based permanent magnet may substantially be a balance of the R-T-B based permanent magnet. Specifically, the content of each element other than the above elements, i.e., the content of each element other than rare earth elements, Fe, Co, Ni, B, Al, Ga, Zr, Cu, and C, may be 0.20 mass % or less, and their total may be 1.00 mass % or less.

### <Method of Manufacturing R-T-B Based Permanent Magnet>

An example method of manufacturing the R-T-B based permanent magnet according to the present embodiment is described below. The method of manufacturing the R-T-B based permanent magnet according to the present embodiment may include the following steps.
(a) an alloy preparation step of preparing a main alloy and a sub alloy
(b) a pulverization step of pulverizing the main alloy and the sub alloy
(c) a mixing step of mixing the main alloy and the sub alloy
(d) a pressing step of pressing a resultant alloy powder
(e) a sintering step of sintering a green compact to give the R-T-B based permanent magnet
(f) an aging treatment step of age-treating the R-T-B based permanent magnet
(g) a cooling step of cooling the R-T-B based permanent magnet
(h) a machining step of machining the R-T-B based permanent magnet
(i) a surface treatment step of surface-treating the R-T-B based permanent magnet

Some or part of the above steps may be omitted as appropriate according to, for example, the type of the R-T-B based permanent magnet eventually manufactured. For example, while the sintering step (step (e)) is included when the R-T-B based permanent magnet is an R-T-B based sintered magnet, the sintering step (step (e)) or the like is not included when the R-T-B based permanent magnet is a bonded magnet. Hot forming or hot working may be employed in place of sintering. Steps other than the above steps may be added as appropriate.

However, in the method of manufacturing the R-T-B based permanent magnet according to the present embodiment, at least the alloy preparation step (step (a)) and the mixing step (step (c)) are always included.

### [Alloy Preparation Step]

First, a main alloy and a sub alloy are prepared (alloy preparation step). The R-T-B based permanent magnet having the above composition is manufactured using a two-alloy method, in which the main alloy and the sub alloy are used. There is no particular difference in a production method between the main alloy and the sub alloy. A strip casting method is described below as an example method of preparing the main alloy, but methods of preparing the alloy are not limited to the strip casting method. With regard to a method of preparing the sub alloy, the “main alloy” in the following description is deemed to be replaced with “sub alloy”.

First, raw material metals corresponding to the composition of the main alloy are prepared and are melted in a vacuum or an inert gas (e.g., Ar gas) atmosphere. Then, the molten raw material metals are casted to prepare the main alloy.

The raw material metals may be of any type. For example, rare earth metals, rare earth alloys, pure iron, pure cobalt, ferro-boron, their alloys, or their compounds can be used. Casting methods of casting the raw material metals are not limited. Examples of casting methods include an ingot casting method, the strip casting method, a book molding method, and a centrifugal casting method. The resultant main alloy may be subject to a homogenization treatment (solution treatment) as necessary when the main alloy has a solidification segregation.

As a method of preparing the alloy, an atomization method may be used instead. In this case, the pulverization step described later may be omitted.

### [Pulverization Step]

A method of pulverizing the main alloy is described below. With regard to a method of pulverizing sub alloy, the “main alloy” in the following description is deemed to be replaced with “sub alloy”.

After the main alloy is prepared, the main alloy is pulverized (pulverization step). The pulverization step may be carried out using a two-step process, which includes a coarse pulverization step of pulverizing the main alloy to a particle size of about several hundred μm to about several mm and a fine pulverization step of finely pulverizing a coarsely pulverized powder to a particle size of about several μm. However, a one-step process consisting solely of the fine pulverization step may be carried out.

### (Coarse Pulverization Step)

The main alloy is coarsely pulverized until it has a particle size of about several hundred μm to about several mm (coarse pulverization step). This gives the coarsely pulverized powder of the main alloy. Coarse pulverization may be carried out using, for example, hydrogen storage pulverization. Hydrogen storage pulverization can be performed by making the main alloy store hydrogen and then release hydrogen based on difference in the amount of stored hydrogen between different phases to bring self-collapsing pulverization. Release of hydrogen based on difference in the amount of stored hydrogen between different phases is referred to as dehydrogenation. Dehydrogenation conditions are not limited. Dehydrogenation is performed, for example, at 300 to 650° C. in an argon flow or a vacuum.

Coarse pulverization methods are not limited to the above-mentioned hydrogen storage pulverization. For example, coarse pulverization may be carried out using a coarse pulverizer, such as a stamp mill, a jaw crusher, or a brown mill, in an inert gas atmosphere.

For the R-T-B based permanent magnet to have high magnetic properties, an atmosphere of each step from the coarse pulverization step to the sintering step described later may be an atmosphere with a low oxygen concentration. The oxygen concentration is adjusted by, for example, control of the atmosphere of each manufacturing step. When the oxygen concentration of each manufacturing step is high, a rare earth element in an alloy powder resulting from pulverizing the main alloy is oxidized to generate rare earth element oxide. The rare earth element oxide is not reduced during sintering and is deposited in the grain boundaries in the form of the rare earth element oxide. The grain boundaries are portions between two or more of the main phase grains. As a result, Br of the resultant R-T-B based permanent magnet decreases. Thus, each step (fine pulverization step, pressing step) may be carried out in an atmosphere having an oxygen concentration of, for example, 100 ppm or less.

### (Fine Pulverization Step)

After the main alloy is coarsely pulverized, the resultant coarsely pulverized powder of the main alloy is finely pulverized until the powder has an average particle size of about several μm (fine pulverization step). This gives a finely pulverized powder of the main alloy. Further pulverizing the coarsely pulverized powder can give the finely pulverized powder. D50 of the particles included in the finely pulverized powder is not limited. For example, D50 may be 2.0 μm or more and 4.5 μm or less or may be 2.5 μm or more and 3.5 μm or less. The smaller the D50, the more easily HcJ of the R-T-B based permanent magnet according to the present embodiment is improved. However, abnormal grain growth tends to occur during the sintering step, decreasing the upper limit of the sintering temperature range. The larger the D50, the less easily abnormal grain growth occurs during the sintering step, increasing the upper limit of the sintering temperature range. However, HcJ of the R-T-B based permanent magnet according to the present embodiment tends to decrease.

Fine pulverization is carried out by further pulverizing the coarsely pulverized powder using a fine pulverizer, such as a jet mill, a ball mill, a vibrating mill, or a wet attritor, while conditions such as pulverization time and the like are adjusted as appropriate. A jet mill is described below. A jet mill is a fine pulverizer in which a high-pressure inert gas (e.g., He gas, N₂ gas, or Ar gas) is released from a narrow nozzle to generate a high-speed gas flow, which accelerates the coarsely pulverized powder of the main alloy to collide against each other or collide with a target or a container wall for pulverization.

When the coarsely pulverized powder of the main alloy is finely pulverized, a pulverization aid may be added. The pulverization aid may be of any type. For example, an organic lubricant or a solid lubricant may be used. Examples of organic lubricants include oleic amide, lauramide, and zinc stearate. Examples of solid lubricants include graphite. Adding the pulverization aid can give the finely pulverized powder such that orientation is easily generated when a magnetic field is applied in the pressing step. Either an organic lubricant or a solid lubricant may be used, or both of them may be mixed and used. This is because, particularly when only a solid lubricant is used, degree of orientation may be decreased.

### [Mixing Step]

Then, the main alloy and sub alloy are mixed to give a pressing alloy powder (mixing step). Any mixing method may be used.

### [Pressing Step]

The pressing alloy powder is pressed into an intended shape (pressing step). In the pressing step, a mold disposed in an electromagnet is filled with the pressing alloy powder, and the powder is pressed, to give a green compact. At this time, pressing the pressing alloy powder while a magnetic field is being applied allows a crystal axis of the pressing alloy powder to be oriented in a specific direction. Because the resultant green compact is oriented in the specific direction, the R-T-B based permanent magnet can have higher magnetic anisotropy. A pressing aid may be added. The pressing aid may be of any type. The same lubricant as the pulverization aid may be used. The pulverization aid may double as the pressing aid.

The pressure applied during pressing may be, for example, 30 MPa or more and 300 MPa or less. The magnetic field applied may be, for example, 1000 kA/m or more and 1600 kA/m or less. The magnetic field applied is not limited to a static magnetic field and can be a pulsed magnetic field. Also, a static magnetic field and a pulsed magnetic field can be used together.

As for a pressing method, other than dry pressing, in which the pressing alloy powder is directly pressed as described above, wet pressing can be used, in which a slurry including the pressing alloy powder dispersed in a solvent (e.g., oil) is pressed.

The green compact resulting from pressing the pressing alloy powder may have any shape according to a desired shape of the R-T-B based permanent magnet. For example, the green compact can have a rectangular parallelepiped shape, a plate shape, a columnar shape, or a ring shape.

### [Sintering Step]

The green compact resulting from pressing the pressing alloy powder into an intended shape in a magnetic field is sintered in a vacuum or an inert gas atmosphere to give the R-T-B based permanent magnet (sintering step). The holding temperature (sintering temperature) and the holding time (sintering time) for sintering need to be adjusted according to conditions, such as a composition, a pulverization method, and a difference in particle size and particle size distribution. The sintering temperature is not limited and may be 1040° C. or more and 1100° C. or less. The sintering time is not limited and may be 1 hour or more and 10 hours or less, 2 hours or more and 8 hours or less, or 3 hours or more and 6 hours or less. The shorter the sintering time, the higher the production efficiency. However, [Zr1] and [Zr2] tend to increase, and magnetic properties, particularly Hk/HcJ, tend to decrease. The longer the sintering time, the more easily magnetic properties are improved. However, production efficiency decreases.

The sintering atmosphere is not limited. For example, an inert gas atmosphere, a less than 100 Pa vacuum atmosphere, or a less than 10 Pa vacuum atmosphere may be used. The heating rate to reach the sintering temperature is not limited. Through sintering, the alloy powder undergoes liquid phase sintering to give the R-T-B based permanent magnet according to the present embodiment. The cooling rate after the green compact is sintered to give the sintered body is not limited. For higher production efficiency, the sintered body may be rapidly cooled. The sintered body may be rapidly cooled at 30° C./min or higher.

### [Aging Treatment Step]

After the green compact is sintered, the R-T-B permanent magnet is age-treated (aging treatment step). After sintering, the resultant R-T-B based permanent magnet is, for example, held at a temperature lower than that of sintering to perform an aging treatment of the R-T-B based permanent magnet. The aging treatment performed in two stages, which are a first aging treatment and a second aging treatment, is described below. However, only either one of them may be performed, or the aging treatment in three or more stages may be performed.

The holding temperature and the holding time of each aging treatment are not limited. For example, the first aging treatment may be performed at a holding temperature of 800° C. or more and 900° C. or less for 30 minutes or more and 4 hours or less. The heating rate to reach the holding temperature may be 5° C./min or higher and 50° C./min or lower. The atmosphere of the first aging treatment may be an inert gas atmosphere (e.g., He gas or Ar gas) under at least atmospheric pressure. The second aging treatment may be performed under the same conditions as the first aging treatment except that the holding temperature may be 450° C. or more and 550° C. or less. The aging treatment can improve the magnetic properties of the R-T-B based permanent magnet. The aging treatment step may be carried out after the machining step described later.

### [Cooling Step]

After the aging treatment (the first aging treatment or the second aging treatment) of the R-T-B based permanent magnet, the R-T-B based permanent magnet is rapidly cooled in an inert gas atmosphere (cooling step). This can give the R-T-B based permanent magnet according to the present embodiment. The cooling rate is not limited and may be 30° C./min or higher.

### [Machining Step]

The resultant R-T-B based permanent magnet may be machined into a desired shape as necessary (machining step). Examples of machining methods include shape machining (e.g., cutting or grinding) and chamfering (e.g., barrel polishing).

### [Grain Boundary Diffusion Step]

Further, a heavy rare earth element or elements may be diffused to the grain boundaries of the machined R-T-B based permanent magnet (grain boundary diffusion step). Methods of grain boundary diffusion are not limited. For example, a compound containing the heavy rare earth element or elements may adhere to a surface of the R-T-B based permanent magnet by coating, deposition, or the like, and then a heat treatment may be performed. Alternatively, the R-T-B based permanent magnet may be subject to a heat treatment in an atmosphere containing a vapor of the heavy rare earth element or elements. Grain boundary diffusion can further improve HcJ of the R-T-B based permanent magnet.

### [Surface Treatment Step]

The R-T-B based permanent magnet resulting from the above steps may be subject to surface treatments, such as plating, resin coating, an oxidizing treatment, and a chemical treatment (surface treatment step). This can further improve the corrosion resistance.

In the above method of manufacturing the R-T-B based permanent magnet, it is important that the composition of the main alloy, the microstructure of the main alloy, the composition of the sub alloy, and the mix ratio of the main alloy to the sub alloy are controlled as appropriate. The main alloy is an alloy that eventually becomes mainly the main phase grains 11, and the sub alloy is an alloy that eventually becomes mainly the grain boundary 13.

### (Composition of Main Alloy)

Out of 100 mass % of the main alloy, the main alloy has at least a C content of 0.070 mass % or more and 0.180 mass % or less. The C content may be 0.080 mass % or more, 0.090 mass % or more, 0.100 mass % or more, or 0.120 mass % or more. The C content may be 0.160 mass % or less. The lower the C content of the main alloy, the less easily a ZrC compound is generated at the time of manufacture of the R-T-B based permanent magnet, and the more easily a ZrB₂ compound is generated at that time. Further, S(C)/(S (B)+S(C)) of the resultant R-T-B based permanent magnet tends to decrease. Further, Br, HcJ, and Hk/HcJ of the resultant R-T-B based permanent magnet tend to decrease. Moreover, the 6-13-1 phase described later tends to be included in the main alloy, and the resultant R-T-B based permanent magnet tends to contain a-Fe. The higher the C content of the main alloy, the more easily HcJ of the resultant R-T-B based permanent magnet decreases.

The content of other components of the main alloy is not limited. For example, out of 100 mass % of the main alloy, the main alloy may have
a rare earth element content of 30.00 mass % or more and 32.50 mass % or less,
an Al content of 0 mass % or more and 0.10 mass % or less,
a Ga content of 0.40 mass % or more and 1.20 mass % or less,
a Cu content of 0.10 mass % or more and 1.00 mass % or less,
a Co content of 0.50 mass % or more and 3.00 mass % or less,
a Zr content of 0.10 mass % or more and 0.80 mass % or less, and
a B content of 0.70 mass % or more and 1.00 mass % or less.

“Out of 100 mass % of the main alloy” indicates that the total content of all elements is 100 mass %. The Fe content of the main alloy may substantially be a balance of the main alloy. Specifically, the content of each element other than rare earth elements, Fe, Co, B, Al, Ga, Zr, Cu, and C, may be 0.20 mass % or less, and their total may be 1.00 mass % or less.

### (Microstructure of Main Alloy)

The percentage of the 6-13-1 phase in the main alloy may be small. Specifically, in a section of the main alloy, the percentage of a phase including an R₆T₁₃M compound, which is a compound having a La₆Co₁₁Ga₃ type crystal structure, may be 0% or more and less than 2.0% or may be 0% or more and 1.0% or less. In general, “M” may be of any type. Examples of “M” include Ga, Al, Cu, Zn, In, P, Sb, Si, Ge, Sn, and Bi.

In general, when the main alloy containing Ga is prepared, the 6-13-1 phase tends to be generated in the main alloy. However, when the main alloy containing Ga and having a C content of 0.070 mass % or more is prepared, generation of the R₆T₁₃M compound is prevented.

When the main alloy containing Ga and not having a C content of 0.070 mass % or more is prepared, the 6-13-1 phase is generated in the main alloy. That is, the R₆T₁₃M compound is deposited in the main alloy. When the R₆T₁₃M compound is deposited in the main alloy, the R₆T₁₃M compound included in the main alloy is decomposed to generate a-Fe at the time of heating the main alloy to a specific temperature range in one or some of the steps of manufacturing the R-T-B based permanent magnet. As a result, magnetic properties (e.g., Hk/HcJ) of the R-T-B based permanent magnet eventually manufactured tend to decrease.

A method of observing the 6-13-1 phase is described below. Together, a method of measuring the area percentage of the 6-13-1 phase is described.

First, a compositional image of a section of the main alloy is observed. An apparatus for observing the compositional image is not limited and may be any apparatus with which the compositional image can be appropriately observed. For example, a SEM may be used. The magnification may be any magnification at which the 6-13-1 phase can be appropriately observed. For example, the magnification may be 1000× or more and 5000× or less. In the compositional image observed using the SEM, the main phase is a dark gray portion, and the R-rich phase is a light gray portion. The 6-13-1 phase is included in the R-rich phase and is a portion thereof darker than the remainder of the R-rich phase.

### (Composition of Sub Alloy)

Out of 100 mass % of the sub alloy, the sub alloy has at least a Zr content of 3.00 mass % or more and 7.00 mass % or less. The lower the Zr content of the sub alloy, the more easily abnormal growth of the main phase grains occurs, which tends to decrease HcJ and Hk/HcJ. The higher the Zr content of the sub alloy, the more easily a ZrB₂ compound is generated at the time of manufacture of the R-T-B based permanent magnet, easily decreasing S(C)/(S(B)+S(C)). Further, HcJ and Hk/HcJ tend to decrease. At the time of manufacture of the R-T-B based permanent magnet, a ZrC compound is less easily generated, and a ZrB₂ compound is more easily generated.

The content of other components of the sub alloy is not limited. For example, out of 100 mass % of the sub alloy, the sub alloy may have
a rare earth element content of 30.00 mass % or more and 45.00 mass % or less,
an Al content of 0 mass % or more and 1.00 mass % or less,
a Ga content of 0 mass % or more and 8.00 mass % or less,
a Cu content of 0 mass % or more and 5.00 mass % or less, and
a Co content of 0 mass % or more and 10.00 mass % or less.

The C content of the sub alloy is not limited. Out of 100 mass % of the sub alloy, the sub alloy may have a C content of, for example, 0.100 mass % or less, 0.090 mass % or less, or 0.050 mass % or less. When the C content of the sub alloy is too high, the C content of the R-T-B based permanent magnet increases, and HcJ tends to decrease.

“Out of 100 mass % of the sub alloy” indicates that the total content of all elements is 100 mass %. The Fe content of the sub alloy may substantially be a balance of the sub alloy. Specifically, the content of each element other than rare earth elements, Fe, Co, Al, Ga, Zr, Cu, and C, may be 0.20 mass % or less, and their total may be 1.00 mass % or less.

### (Comparison Between Main Alloy and Sub Alloy)

When the main alloy and the sub alloy are compared, they may be as follows. The main alloy may have a higher Ga content. The main alloy may have a higher Cu content. The sub alloy may have a higher Co content. The sub alloy may have a higher Zr content. The main alloy may have a higher B content. The main alloy may have a higher C content.

### (Mix Ratio of Main Alloy to Sub Alloy)

The main alloy and the sub alloy are mixed at a ratio of 85:15 to 92:8 based on mass. When the composition of the R-T-B based permanent magnet eventually manufactured is close to the composition of another R-T-B based permanent magnet but includes too less main alloy, Hk/HcJ of the former R-T-B based permanent magnet tends to decrease. When the composition of the R-T-B based permanent magnet eventually manufactured is close to the composition of the another R-T-B based permanent magnet but includes too much main alloy, magnetic properties, particularly Hk/HcJ, of the former R-T-B based permanent magnet tend to decrease.

The R-T-B based permanent magnet resulting as above has good magnetic properties. That is, the R-T-B based permanent magnet having high magnetic properties can be manufactured with a relatively small usage of a heavy rare earth element, a relatively low B content, and/or a relatively short sintering time.

The present disclosure is not limited to the above embodiment and can variously be modified within the scope of the present disclosure.

### Second Embodiment

Hereinafter, a second embodiment is described. The second embodiment is the same as or similar to the first embodiment unless otherwise specified.

An R-T-B based permanent magnet of the second embodiment has a microstructure different from that of the first embodiment.

The R-T-B based permanent magnet includes a main phase grain and a grain boundary; and has
a [Zr1]/[Zr2] of 0.70 or more and 1.20 or less in atomic ratio, where [Zr1] denotes a Zr concentration of a center portion of the main phase grain and [Zr2] denotes a Zr concentration of a peripheral portion of the main phase grain, and
a S(C)/(S(B)+S(C)) of 98.0% or more, where S(B) denotes a total area of ZrB₂ in the grain boundary and S(C) denotes a total area of ZrC in the grain boundary,
in a section of the R-T-B based permanent magnet.

In the R-T-B based permanent magnet, difference between the Zr concentration of the center portion of the main phase grain and the Zr concentration of the peripheral portion of the main phase grain is small. That is, the main phase grain has an approximately uniform Zr concentration. Further, a high ratio of ZrC to a total of ZrB₂ and ZrC among Zr compounds contained in the grain boundary enables the R-T-B based permanent magnet to have suitable Br, HcJ, and Hk/HcJ. In particular, even when the R-T-B based permanent magnet has a relatively low heavy rare earth element content, has a relatively low B content, and/or has a relatively short sintering time, the R-T-B based permanent magnet can have suitable Br, HcJ, and Hk/HcJ.

When [Zr1]/[Zr2] is too high, HcJ and Hk/HcJ decrease. When S(C)/(S(B)+S(C)) is too low, Br and Hk/HcJ decrease, and further HcJ tends to decrease.

[Zr1] may be 0 or more and 0.50 at % or less. [Zr2] may be 0 or more and 0.72 at % or less.

A method of measuring [Zr1] and [Zr2] of the main phase grain included in the R-T-B based permanent magnet is described below.

First, elemental mapping of a section of the R-T-B based permanent magnet is performed. An apparatus for performing elemental mapping is not limited and may be any apparatus with which elemental mapping can be appropriately performed. For example, an EPMA or EDS may be used. The magnification may be any magnification at which [Zr1] and [Zr2] can be appropriately measured. For example, the magnification may be 1500× or more and 10000× or less. Elemental mapping gives an image shown as, for example, FIG. 1.

The R-T-B based permanent magnet 1 shown in FIG. 1 is the Sample No. 3 example described later. The R-T-B based permanent magnet 1 includes the main phase grain 11 and the grain boundary 13. The grain boundary 13 includes the R-containing portion 13a and the Zr-containing portion 13b.

The R-containing portion 13a is a portion particularly rich in the R-rich phase and/or the 6-13-1 phase in the grain boundary 13. The R-rich phase is a phase that is rich in at least “R” and is richer in Co, Cu, and/or Ga than the main phase grain 11. The 6-13-1 phase is a phase that is rich in “R”, Fe, Co, Cu, and Ga.

The Zr-containing portion 13b is a portion particularly rich in Zr compounds in the grain boundary 13.

The grain boundary 13 may include a portion that is difficult to be identified as the R-containing portion 13a or the Zr-containing portion 13b for being rich in both “R”, Co, Cu, and/or Ga and Zr.

The location and the shape of the main phase grain 11 included in the resulting elemental mapping image are identified. At this time, the elemental mapping image may be enlarged as appropriate. For example, FIG. 3 is an enlarged image of the part A of FIG. 1. Then, the center portion of the main phase grain 11 included in its entirety in the elemental mapping image is identified. Specifically, a portion of the main phase grain 11 in the elemental mapping image apart from the surface of the main phase grain 11 by a distance of 40% or more of the equivalent circle diameter of that main phase grain is defined as the center portion of the main phase grain 11. In other words, the center portion is where the distance from the border between the main phase grain 11 and the grain boundary 13 is 40% or more of the equivalent circle diameter of that main phase grain. The Zr concentration of the center portion of the main phase grain 11 is measured and is defined as [Zr1]. Note that a target main phase grain whose [Zr1] and [Zr2] are measured is a main phase grain 11 having a region satisfying the definition of the center portion and a region satisfying the definition of the peripheral portion described later.

When [Zr1] of the R-T-B based permanent magnet 1 is calculated, the elemental mapping image is observed so that the number of main phase grains 11 being included in their entirety in the image and each having the center portion is at least three. The number of main phase grains 11 being included in their entirety in the image and each having the center portion may be five or more. [Zr1] of the R-T-B based permanent magnet 1 may be calculated by measuring [Zr1] of each of the main phase grains 11 included in their entirety in the elemental mapping image and averaging the measurement.

A method of measuring [Zr2] is the same as the method of measuring [Zr1] except that a portion subject to Zr concentration measurement is changed from the center portion of the main phase grain 11 to the peripheral portion of the main phase grain 11. Specifically, the peripheral portion of the main phase grain 11 is a portion apart from the surface of the main phase grain 11 in the elemental mapping image by a distance of 30% or less of the equivalent circle diameter of that main phase grain. In other words, the peripheral portion is located where the distance from the border between the main phase grain 11 and the grain boundary 13 is 30% or less of the equivalent circle diameter of that main phase grain. In order not to detect a grain boundary component in measurement of [Zr2], a portion apart from the surface of the main phase grain 11 by a distance of 15% or more and 30% or less of the equivalent circle diameter of that main phase grain may be subject to measurement.

When [Zr1]/[Zr2] of the individual main phase grain 11 is calculated, [Zr1] and [Zr2] of the individual main phase grain 11 are measured for calculation. When [Zr1]/[Zr2] of the R-T-B based permanent magnet 1 is calculated, [Zr1] of the R-T-B based permanent magnet 1 calculated using the above method is divided by [Zr2] of the R-T-B based permanent magnet 1 calculated using the above method.

The R-T-B based permanent magnet 2 shown in FIG. 2 is the Sample No. 10 comparative example described later. FIG. 4 is an enlarged image of the part B of FIG. 2. According to FIGS. 2 and 4, the R-T-B based permanent magnet 2 shown in FIG. 2 has a higher Zr concentration of the main phase grain 11 than the R-T-B based permanent magnet 1 shown in FIG. 1. In particular, it seems that the Zr concentration of the center portion of the main phase grain 11 is high and that, according to Zr concentration distribution, the main phase grain 11 is a core-shell grain including a shell with a low Zr concentration and a core with a high Zr concentration. That is, because [Zr1]/[Zr2] of the R-T-B based permanent magnet 2 is too high, the R-T-B based permanent magnet 2 has low HcJ and low Hk/HcJ.

### Examples

Hereinafter, the present disclosure is described in further detail using examples. However, the present disclosure is not limited to these examples.

### Experiment 1

### (Alloy Preparation Step)

In an alloy preparation step, main alloys, sub alloys, and a one-alloy method alloy, all of which eventually had compositions shown in Tables 1 to 3, were prepared. “TRE” indicates the rare earth element content. The content of each element other than Fe not shown in Tables 1 to 3 was less than 0.01 mass %. That is, Fe was substantially a balance in each Example or Comparative Example shown in Tables 1 to 3.

The compositions of R-T-B based permanent magnets eventually manufactured in Experiment 1 were substantially the same except for the Zr content and the C content.

First, raw material metals containing predetermined elements were prepared. As the raw material metals, for example, simple substances of elements shown in Tables 1 to 3, alloys containing elements shown in Tables 1 to 3, and/or compounds containing elements shown in Tables 1 to 3 were selected as appropriate and prepared.

Then, these raw material metals were weighed, and a strip casting method was used to prepare the main alloys, the sub alloys, and the one-alloy method alloy. The carbon content of each alloy was controlled by changing, for example, the proportion of pig iron used as a raw material metal.

### (Pulverization Step)

In a pulverization step, each alloy resulting from the alloy preparation step was pulverized to give an alloy powder. Pulverization was carried out in two steps, which were coarse pulverization and fine pulverization. Coarse pulverization was carried out using hydrogen storage pulverization. After each alloy stored hydrogen, dehydrogenation was performed in an argon flow or a vacuum at 300 to 600° C. Coarse pulverization gave an alloy powder having a particle size of about several hundred μm to about several mm.

Fine pulverization was carried out with a jet mill after oleic amide was added as a pulverization aid to the alloy powder resulting from coarse pulverization and was mixed with the powder. The amount of the pulverization aid added was determined so that the compositions of the magnets eventually manufactured were as shown in Table 4. For the jet mill, a nitrogen gas was used. Fine pulverization was carried out until the alloy powder had a D50 of about 3.0 μm.

### (Mixing Step)

For each sample other than Sample No. 10, an alloy powder resulting from pulverizing the main alloy shown in Table 4 and an alloy powder resulting from pulverizing the sub alloy shown in Table 4 were mixed at a mix ratio shown in Table 4 to give a pressing alloy powder. For Sample No. 10, an alloy α after fine pulverization was used as a pressing alloy powder as shown in Table 4.

### (Pressing Step)

In a pressing step, the pressing alloy powder resulting from the pulverization step and the mixing step was pressed in a magnetic field to give a green compact. After a mold disposed in an electromagnet was filled with the alloy powder, the powder was pressed while a magnetic field was applied using the electromagnet. The magnetic field applied was 1200 kA/m. The pressure applied during pressing was 40 MPa.

### (Sintering Step)

In a sintering step, the resultant green compact was sintered to give a sintered body. The holding temperature (sintering temperature) for sintering was 1080° C. The holding time (sintering time) for sintering was as shown in Table 4. The heating rate to reach the holding temperature was 8.0° C./min. The cooling rate to cool from the holding temperature to room temperature was 50° C./min. The sintering atmosphere was a vacuum atmosphere or an inert gas atmosphere.

### (Aging Treatment Step)

In an aging treatment step, the resultant sintered body was subject to an aging treatment to give each R-T-B based permanent magnet. The aging treatment was performed in two stages, which were a first aging treatment and a second aging treatment.

In the first aging treatment, the heating rate to reach the holding temperature was 8.0° C./min. The holding temperature was 900° C. The holding time was 1.0 hour. The cooling rate to cool from the holding temperature to room temperature was 50° C./min. The atmosphere of the first aging treatment was an Ar atmosphere.

In the second aging treatment, the heating rate to reach the holding temperature was 8.0° C./min. The holding temperature was 500° C. The holding time was 1.5 hours. The cooling rate to cool from the holding temperature to room temperature was 50° C./min. The atmosphere of the second aging treatment was an Ar atmosphere.

Through compositional analyses such as a fluorescent X-ray analysis, inductively coupled plasma emission spectroscopic analysis (ICP analysis), and a gas analysis, it was confirmed that the composition of the R-T-B based permanent magnet eventually manufactured in each Example or Comparative Example was as shown in Table 4. In particular, the C content was measured using a combustion in an oxygen airflow-infrared absorption method. The B content was measured using ICP analysis.

### (Evaluation)

### (Area Percentage of 6-13-1 Phase of Main Alloy)

A section of each main alloy shown in Table 1 was observed using a SEM (SU5000 manufactured by Hitachi High-Tech Corporation) at an accelerating voltage of 3.0 kV, at a magnification of 2000×, and with contrast and brightness being adjusted so that a main phase, an R-rich phase, and a 6-13-1 phase can be distinguished. Then, the areas of these phases were analyzed, and the area of the 6-13-1 phase was divided by the area of the observed section to calculate the area percentage of the 6-13-1 phase. Table 1 shows the results. Note that, in Experiment 1, the 6-13-1 phase was not observed in the main alloys except for an alloy A.

### ([Zr1], [Zr2])

Elemental mapping of a section of each magnet shown in Table 4 was performed using an EPMA (JXA-8500F manufactured by JEOL Ltd.) at an accelerating voltage of 15 kV, an illumination current of 100 nA, at an analysis step of 0.20 nm/step, for a field of view having a size of 51.2 μm×51.2 μm. The locations and the shapes of main phase grains included in the resulting elemental mapping image were identified. It was confirmed that the number of main phase grains being included in their entirety in the elemental mapping image and each having a region satisfying the definition of the center portion and a region satisfying the definition of the peripheral portion was fifty or more. Then, for each main phase grain being included in its entirety in the elemental mapping image and having a region satisfying the definition of the center portion and a region satisfying the definition of the peripheral portion, a measurement point was determined at a location apart from a surface of the main phase grain by a distance of 40% or more of the equivalent circle diameter of the main phase grain, and its Zr concentration was measured there. By averaging the Zr concentrations of respective measurement points, [Zr1] of each magnet was calculated. Note that, with regard to calculation of [Zr1] of each magnet, one main phase grain had one measurement point at which the Zr concentration was measured.

For each main phase grain being included in its entirety in the elemental mapping image and having a region satisfying the definition of the center portion and a region satisfying the definition of the peripheral portion, a measurement point was determined at a location apart from the surface of the main phase grain by a distance of 30% or less of the equivalent circle diameter of the main phase grain, and its Zr concentration was measured there. By averaging the Zr concentrations of respective measurement points, [Zr2] of each magnet was calculated. Further, [Zr1]/[Zr2] of each magnet was calculated. Table 5 shows the results. Note that, with regard to calculation of [Zr2] of each magnet, one main phase grain had one measurement point at which the Zr concentration was measured.

(S(C)/(S(B)+S(C)))

A section of each magnet shown in Table 4 was observed using a SEM, at a magnification of 1500×, for three locations. For all resulting SEM images, ZrB₂ and/or ZrC in grain boundary phases were identified. The total area of ZrB₂ was defined as S(B). The total area of ZrC was defined as S(C). Then, S(C)/(S(B)+S(C)) was calculated. Table 5 shows the results. Note that, in samples other than Sample Nos. 1 and 9, presence of ZrB₂ was not confirmed.

The equivalent circle diameter of the largest Zr compound among Zr compounds included in the above SEM images was defined as the maximum grain size of the Zr compounds. Table 5 shows the results. Note that, in all Examples and Comparative Examples, Zr compounds other than ZrB₂ and ZrC were not observed.

### (Magnetic Properties)

Magnetic properties of the R-T-B based permanent magnet of each Example or Comparative Example were measured using a B-H tracer. Specifically, Br, HcJ, and Hk/HcJ were measured. Table 5 shows the results.

In Experiments 1 to 3, Br was defined as good at 1330 mT or more. HcJ was defined as good at 1850 kA/m or more. Hk/HcJ was defined as good at 95.0% or more.

TABLE 1

| | | | | | | | | | | | | Area |
|---|---|---|---|---|---|---|---|---|---|---|---|---|
| | | | | | | | | | | | | percentage |
| | | | | | | | | | | | | of 6-13-1 |
| Main | Alloy composition (mass %) | | | | | | | | | | | phase |
| alloy | Nd | Pr | TRE | Al | Fe | Ga | Cu | Co | Zr | B | C | (%) |
| Alloy A | 25.44 | 6.56 | 32.00 | 0.04 | Bal. | 0.88 | 0.32 | 1.60 | 0.56 | 0.87 | 0.060 | 2.0 |
| Alloy B | 25.44 | 6.56 | 32.00 | 0.04 | Bal. | 0.88 | 0.32 | 1.60 | 0.56 | 0.87 | 0.120 | 0.0 |
| Alloy C | 25.44 | 6.56 | 32.00 | 0.04 | Bal. | 0.88 | 0.32 | 1.60 | 0.56 | 0.87 | 0.155 | 0.0 |
| Alloy D | 25.44 | 6.56 | 32.00 | 0.04 | Bal. | 0.88 | 0.32 | 1.60 | 0.56 | 0.87 | 0.180 | 0.0 |
| Alloy E | 25.44 | 6.56 | 32.00 | 0.04 | Bal. | 0.88 | 0.32 | 1.60 | 0.56 | 0.87 | 0.200 | 0.0 |

TABLE 2

| Sub | Alloy composition (mass %) | | | | | | | | | | |
|---|---|---|---|---|---|---|---|---|---|---|---|
| alloy | Nd | Pr | TRE | Al | Fe | Ga | Cu | Co | Zr | B | C |
| Alloy a | 25.44 | 6.56 | 32.00 | 0.04 | Bal. | 0.00 | 0.06 | 5.10 | 0.00 | 0.00 | 0.010 |
| Alloy b | 25.44 | 6.56 | 32.00 | 0.04 | Bal. | 0.00 | 0.06 | 5.10 | 3.00 | 0.00 | 0.010 |
| Alloy c | 25.44 | 6.56 | 32.00 | 0.04 | Bal. | 0.00 | 0.06 | 5.10 | 5.33 | 0.00 | 0.010 |
| Alloy d | 25.44 | 6.56 | 32.00 | 0.04 | Bal. | 0.00 | 0.06 | 5.10 | 7.00 | 0.00 | 0.010 |
| Alloy e | 25.44 | 6.56 | 32.00 | 0.04 | Bal. | 0.00 | 0.06 | 5.10 | 10.00 | 0.00 | 0.010 |

TABLE 3

| One-alloy | | | | | | | | | | | |
|---|---|---|---|---|---|---|---|---|---|---|---|
| method | Alloy composition (mass %) | | | | | | | | | | |
| alloy | Nd | Pr | TRE | Al | Fe | Ga | Cu | Co | Zr | B | C |
| Alloy α | 25.44 | 6.56 | 32.00 | 0.04 | Bal. | 0.79 | 0.29 | 1.95 | 1.04 | 0.78 | 0.141 |

TABLE 4

| | Example/ | | | Mix | Sin- | | | | | | | | | | | | C at- |
|---|---|---|---|---|---|---|---|---|---|---|---|---|---|---|---|---|---|
| | Compar- | | | ratio | tering | | | | | | | | | | | | tributed |
| Sample | ative | Main | Sub | (based | time | Magnet composition (mass %) | | | | | | | | | | | to alloy |
| No. | Example | alloy | alloy | on mass) | (h) | Nd | Pr | TRE | Al | Fe | Ga | Cu | Co | Zr | B | C | (mass %) |
| 1 | Compar- | Alloy A | Alloy c | 90:10 | 4 | 25.44 | 6.56 | 32.00 | 0.04 | Bal. | 0.79 | 0.29 | 1.95 | 1.04 | 0.78 | 0.140 | 0.055 |
| | ative | | | | | | | | | | | | | | | | |
| | Example | | | | | | | | | | | | | | | | |
| 2 | Example | Alloy B | Alloy c | 90:10 | 4 | 25.44 | 6.56 | 32.00 | 0.04 | Bal. | 0.79 | 0.29 | 1.95 | 1.04 | 0.78 | 0.194 | 0.109 |
| 3 | Example | Alloy C | Alloy c | 90:10 | 4 | 25.44 | 6.56 | 32.00 | 0.04 | Bal. | 0.79 | 0.29 | 1.95 | 1.04 | 0.78 | 0.226 | 0.141 |
| 4 | Example | Alloy D | Alloy c | 90:10 | 4 | 25.44 | 6.56 | 32.00 | 0.04 | Bal. | 0.79 | 0.29 | 1.95 | 1.04 | 0.78 | 0.248 | 0.163 |
| 5 | Compar- | Alloy E | Alloy c | 90:10 | 4 | 25.44 | 6.56 | 32.00 | 0.04 | Bal. | 0.79 | 0.29 | 1.95 | 1.04 | 0.78 | 0.266 | 0.181 |
| | ative | | | | | | | | | | | | | | | | |
| | Example | | | | | | | | | | | | | | | | |
| 6 | Compar- | Alloy C | Alloy a | 90:10 | 4 | 25.44 | 6.56 | 32.00 | 0.04 | Bal. | 0.79 | 0.29 | 1.95 | 0.50 | 0.78 | 0.226 | 0.141 |
| | ative | | | | | | | | | | | | | | | | |
| | Example | | | | | | | | | | | | | | | | |
| 7 | Example | Alloy C | Alloy b | 90:10 | 4 | 25.44 | 6.56 | 32.00 | 0.04 | Bal. | 0.79 | 0.29 | 1.95 | 0.80 | 0.78 | 0.226 | 0.141 |
| 3 | Example | Alloy C | Alloy c | 90:10 | 4 | 25.44 | 6.56 | 32.00 | 0.04 | Bal. | 0.79 | 0.29 | 1.95 | 1.04 | 0.78 | 0.226 | 0.141 |
| 8 | Example | Alloy C | Alloy d | 90:10 | 4 | 25.44 | 6.56 | 32.00 | 0.04 | Bal. | 0.79 | 0.29 | 1.95 | 1.20 | 0.78 | 0.226 | 0.141 |
| 9 | Compar- | Alloy C | Alloy e | 90:10 | 4 | 25.44 | 6.56 | 32.00 | 0.04 | Bal. | 0.79 | 0.29 | 1.95 | 1.50 | 0.78 | 0.226 | 0.141 |
| | ative | | | | | | | | | | | | | | | | |
| | Example | | | | | | | | | | | | | | | | |

| | | | | | | | | | | | | | | | |
|---|---|---|---|---|---|---|---|---|---|---|---|---|---|---|---|
| 10 | Compar- | Alloy α only | 4 | 25.44 | 6.56 | 32.00 | 0.04 | Bal. | 0.79 | 0.29 | 1.95 | 1.04 | 0.78 | 0.226 | 0.141 |
| | ative | | | | | | | | | | | | | | |
| | Example | | | | | | | | | | | | | | |

TABLE 5

| | | | | | | Zr | | | |
|---|---|---|---|---|---|---|---|---|---|
| | | | | | | compound | | | |
| | Example/ | | | | S(C)/ | max | | | |
| Sample | Comparative | [Zr1] | [Zr2] | [Zr1]/ | (S(B) + S(C)) | grain size | Br | HcJ | Hk/HcJ |
| No. | Example | (at %) | (at %) | [Zr2] | (%) | (μm) | (mT) | (kA/m) | (%) |
| 1 | Comparative | 0.09 | 0.07 | 1.29 | 75.0 | 0.5 | 1320 | 1730 | 72.1 |
| | Example | | | | | | | | |
| 2 | Example | 0.07 | 0.07 | 1.00 | 100 | 0.5 | 1348 | 1880 | 96.1 |
| 3 | Example | 0.07 | 0.07 | 1.00 | 100 | 0.5 | 1349 | 1892 | 96.8 |
| 4 | Example | 0.07 | 0.08 | 0.88 | 100 | 0.5 | 1347 | 1874 | 97.3 |
| 5 | Comparative | 0.07 | 0.08 | 0.88 | 100 | 0.5 | 1354 | 1833 | 97.2 |
| | Example | | | | | | | | |
| 6 | Comparative | 0.06 | 0.04 | 1.50 | 100 | 0.5 | 1374 | 1840 | 89.2 |
| | Example | | | | | | | | |
| 7 | Example | 0.07 | 0.07 | 1.00 | 100 | 0.5 | 1358 | 1886 | 97.2 |
| 3 | Example | 0.07 | 0.07 | 1.00 | 100 | 0.5 | 1349 | 1892 | 96.8 |
| 8 | Example | 0.08 | 0.09 | 0.89 | 100 | 0.5 | 1338 | 1899 | 96.9 |
| 9 | Comparative | 0.10 | 0.12 | 0.83 | 97.7 | 0.5 | 1324 | 1867 | 92.2 |
| | Example | | | | | | | | |
| 10 | Comparative | 0.42 | 0.10 | 4.20 | 100 | 0.5 | 1336 | 1670 | 72.5 |
| | Example | | | | | | | | |

The R-T-B based permanent magnet of each Example had good Br, good HcJ, and good Hk/HcJ.

Sample No. 1 had too low a carbon content of the main alloy. As a result, S(C)/(S(B)+S(C)) was too low; and Br, HcJ, and Hk/HcJ decreased.

Sample No. 5 had too high a carbon content of the main alloy. As a result, the R-T-B based permanent magnet eventually manufactured had too high a carbon content and had a decreased HcJ.

Sample No. 6 had too low a Zr content of the sub alloy. As a result, HcJ and Hk/HcJ decreased. It was assumed that the decrease in HcJ and Hk/HcJ was because of abnormal grain growth of the main phase grains.

Sample No. 9 had too high a Zr content of the sub alloy. As a result, S(C)/(S(B)+S(C)) was too low; and Br and Hk/HcJ decreased.

In Sample No. 10, which had the same composition as Sample No. 3 but was manufactured using a one-alloy method, [Zr1] was too high, and [Zr1]/[Zr2] was too high. As a result, HcJ and Hk/HcJ decreased.

### Experiment 2

Experiment 2 was conducted as in Sample No. 3 except that the sintering time varied.

Table 6 shows the results.

TABLE 6

| | | | | | | | Zr | | | |
|---|---|---|---|---|---|---|---|---|---|---|
| | | | | | | | compound | | | |
| | Example/ | Sintering | | | | S(C)/ | max | | | |
| Sample | Comparative | time | [Zr1] | [Zr2] | [Zr1]/ | (S(B) + S(C)) | grain size | Br | HcJ | Hk/HcJ |
| No. | Example | (h) | (at %) | (at %) | [Zr2] | (%) | (μm) | (mT) | (kA/m) | (%) |
| 11 | Example | 1 | 0.10 | 0.13 | 0.77 | 100 | 0.5 | 1344 | 1872 | 95.1 |
| 12 | Example | 2 | 0.07 | 0.10 | 0.70 | 100 | 0.5 | 1349 | 1892 | 96.2 |
| 3 | Example | 4 | 0.07 | 0.07 | 1.00 | 100 | 0.5 | 1349 | 1892 | 96.8 |
| 13 | Example | 8 | 0.06 | 0.06 | 1.00 | 100 | 0.5 | 1349 | 1901 | 97.2 |
| 14 | Example | 10 | 0.06 | 0.06 | 1.00 | 100 | 0.5 | 1351 | 1890 | 97.1 |

Even with varied sintering time, each Example having [Zr1], [Zr1]/[Zr2], and S(C)/(S (B)+S(C)) within predetermined ranges had good Br, good HcJ, and good Hk/HcJ.

### Experiment 3

Sample Nos. 16 and 17 were manufactured, each of which had a mix ratio (the main alloy: the sub alloy) varying from that of Sample No. 3 and had compositions of the main alloy and the sub alloy varying from those of Sample No. 3 so that the R-T-B based permanent magnet eventually manufactured had substantially the same composition as Sample No. 3. Tables 7 to 10 show the results.

TABLE 7

| | | | | | | | | | | | | Area |
|---|---|---|---|---|---|---|---|---|---|---|---|---|
| | | | | | | | | | | | | percentage |
| | | | | | | | | | | | | of 6-13-1 |
| Main | Alloy composition (mass %) | | | | | | | | | | | phase |
| alloy | Nd | Pr | TRE | Al | Fe | Ga | Cu | Co | Zr | B | C | (%) |
| Alloy G | 25.44 | 6.56 | 32.00 | 0.04 | Bal. | 0.93 | 0.34 | 1.40 | 0.56 | 0.92 | 0.165 | 0.0 |
| Alloy C | 25.44 | 6.56 | 32.00 | 0.04 | Bal. | 0.88 | 0.32 | 1.60 | 0.56 | 0.87 | 0.155 | 0.0 |
| Alloy H | 25.44 | 6.56 | 32.00 | 0.04 | Bal. | 0.86 | 0.32 | 1.68 | 0.56 | 0.85 | 0.152 | 0.0 |

TABLE 8

| Sub | Alloy composition (mass %) | | | | | | | | | | |
|---|---|---|---|---|---|---|---|---|---|---|---|
| alloy | Nd | Pr | TRE | Al | Fe | Ga | Cu | Co | Zr | B | C |
| Alloy g | 25.44 | 6.56 | 32.00 | 0.04 | Bal. | 0.00 | 0.06 | 5.10 | 4.00 | 0.00 | 0.010 |
| Alloy c | 25.44 | 6.56 | 32.00 | 0.04 | Bal. | 0.00 | 0.06 | 5.10 | 5.33 | 0.00 | 0.010 |
| Alloy h | 25.44 | 6.56 | 32.00 | 0.04 | Bal. | 0.00 | 0.06 | 5.10 | 7.00 | 0.00 | 0.010 |

TABLE 9

| | Example/ | | | Mix | Sin- | | | | | | | | | | | | C at- |
|---|---|---|---|---|---|---|---|---|---|---|---|---|---|---|---|---|---|
| Sam- | Compar- | | | ratio | tering | | | | | | | | | | | | tributed |
| ple | ative | Main | Sub | (based | time | Magnet composition (mass %) | | | | | | | | | | | to alloy |
| No. | Example | alloy | alloy | on mass) | (h) | Nd | Pr | TRE | Al | Fe | Ga | Cu | Co | Zr | B | C | (mass %) |
| 16 | Example | Alloy G | Alloy g | 85:15 | 4 | 25.44 | 6.56 | 32.00 | 0.04 | Bal. | 0.79 | 0.29 | 1.96 | 1.08 | 0.78 | 0.227 | 0.142 |
| 3 | Example | Alloy C | Alloy c | 90:10 | 4 | 25.44 | 6.56 | 32.00 | 0.04 | Bal. | 0.79 | 0.29 | 1.95 | 1.04 | 0.78 | 0.226 | 0.141 |
| 17 | Example | Alloy H | Alloy h | 92:8 | 4 | 25.44 | 6.56 | 32.00 | 0.04 | Bal. | 0.79 | 0.30 | 1.95 | 1.08 | 0.78 | 0.226 | 0.141 |

TABLE 10

| | | | | | | Zr | | | |
|---|---|---|---|---|---|---|---|---|---|
| | | | | | | compound | | | |
| | Example/ | | | | S(C)/ | max | | | |
| Sample | Comparative | [Zr1] | [Zr2] | [Zr1]/ | (S(B)+S(C)) | grain size | Br | HcJ | Hk/HcJ |
| No. | Example | (at %) | (at %) | [Zr2] | (%) | (μm) | (mT) | (kA/m) | (%) |
| 16 | Example | 0.08 | 0.10 | 0.80 | 100 | 0.5 | 1345 | 1889 | 96.8 |
| 3 | Example | 0.07 | 0.07 | 1.00 | 100 | 0.5 | 1349 | 1892 | 96.8 |
| 17 | Example | 0.07 | 0.09 | 0.78 | 100 | 0.5 | 1353 | 1878 | 97.4 |

Even with varied mix ratios, each Example having [Zr1], [Zr1]/[Zr2], and S(C)/(S(B)+S(C)) within the predetermined ranges had good Br, good HcJ, and good Hk/HcJ.

### Experiment 4

Experiment 4 is described below. Experiment 4 was conducted as in Experiment 1 unless a method of producing each sample was otherwise specified.

### (Alloy Preparation Step)

In the alloy preparation step, main alloys, sub alloys, and a one-alloy method alloy, all of which eventually had compositions shown in Tables 11 to 13, were prepared. “TRE” indicates the rare earth element content. The content of each element other than Fe not shown in Tables 11 to 13 was less than 0.01 mass %. That is, Fe was substantially a balance in each Example or Comparative Example shown in Tables 11 to 13.

The compositions of R-T-B based permanent magnets eventually manufactured in Experiment 4 were substantially the same except for the Zr content and the C content.

First, raw material metals containing predetermined elements were prepared. As the raw material metals, for example, simple substances of elements shown in Tables 11 to 13, alloys containing elements shown in Tables 11 to 13, and/or compounds containing elements shown in Tables 11 to 13 were selected as appropriate and prepared.

### (Mixing Step)

For each sample other than Sample No. 28, an alloy powder resulting from pulverizing the main alloy shown in Table 14 and an alloy powder resulting from pulverizing the sub alloy shown in Table 14 were mixed at a mix ratio shown in Table 14 to give a pressing alloy powder. For Sample No. 28, an alloy β after fine pulverization was used as a pressing alloy powder as shown in Table 14.

### (Evaluation)

### (Area Percentage of 6-13-1 Phase of Main Alloy)

A section of each main alloy shown in Table 11 was observed using a SEM at a magnification of 10000×. Each SEM image was visually observed, and whether each portion was a main phase, a grain boundary phase other than a 6-13-1 phase, or a 6-13-1 phase was identified. Then, the area percentage of the 6-13-1 phase was calculated. Table 11 shows the results. Note that, in Experiment 4, the 6-13-1 phase was not observed in the main alloys except for an alloy J.

### ([Zr1], [Zr2])

Elemental mapping of a section of each magnet shown in Table 14 was performed using an EPMA for a field of view of 51.2 μm×51.2 μm. The locations and the shapes of main phase grains included in the resulting elemental mapping image were identified. It was confirmed that the number of main phase grains that were included in their entirety in the elemental mapping image and had an equivalent circle diameter of above 2.5 μm was fifty or more. Then, the Zr concentration of a portion that was deep by more than 1.0 μm from a surface of each of the main phase grains included in their entirety in the elemental mapping image was measured. By averaging the Zr concentrations of the portions of the main phase grains deep from their surfaces by more than 1.0 μm, [Zr1] of each magnet was calculated. Note that, with regard to calculation of [Zr1] of each magnet, one main phase grain had one measurement point at which the Zr concentration was measured.

A measurement point was determined that was deep by 0.3 μm from the surface of each of the main phase grains that were included in their entirety in the elemental mapping image and had an equivalent circle diameter of above 2.5 μm, and the Zr concentration was measured there. By averaging the Zr concentrations of respective measurement points, [Zr2] of each magnet was calculated. Further, [Zr1]/[Zr2] of each magnet was calculated. Table 15 shows the results. Note that, with regard to calculation of [Zr2] of each magnet, one main phase grain had one measurement point at which the Zr concentration was measured.

(S(C)/(S(B)+S(C)))

A section of each magnet shown in Table 14 was observed using a SEM, at a magnification of 1500×, for three locations. For all resulting SEM images, ZrB₂ and/or ZrC in grain boundary phases were identified. The total area of ZrB₂ was defined as S(B). The total area of ZrC was defined as S(C). Then, S(C)/(S(B)+S(C)) was calculated. Table 15 shows the results. Note that, in samples other than Sample Nos. 19 and 27, presence of ZrB₂ was not confirmed.

The equivalent circle diameter of the largest Zr compound among Zr compounds included in the above SEM images was defined as the maximum grain size of the Zr compounds. Table 15 shows the results.

### (Magnetic Properties)

Magnetic properties of the R-T-B based permanent magnet of each Example or Comparative Example were measured using a B-H tracer. Specifically, Br, HcJ, and Hk/HcJ were measured. Table 15 shows the results.

In Experiments 4 to 6, Br was defined as good at 1350 mT or more. HcJ was defined as good at 1730 kA/m or more. Hk/HcJ was defined as good at 95.0% or more.

TABLE 11

| | | | | | | | | | | | | Area |
|---|---|---|---|---|---|---|---|---|---|---|---|---|
| | | | | | | | | | | | | percentage |
| | | | | | | | | | | | | of 6-13-1 |
| Main | Alloy composition (mass %) | | | | | | | | | | | phase |
| alloy | Nd | Pr | TRE | Al | Fe | Ga | Cu | Co | Zr | B | C | (%) |
| Alloy J | 24.88 | 6.42 | 31.30 | 0.04 | Bal. | 0.70 | 0.25 | 1.60 | 0.56 | 0.89 | 0.060 | 2.0 |
| Alloy K | 24.88 | 6.42 | 31.30 | 0.04 | Bal. | 0.70 | 0.25 | 1.60 | 0.56 | 0.89 | 0.090 | 0.0 |
| Alloy L | 24.88 | 6.42 | 31.30 | 0.04 | Bal. | 0.70 | 0.25 | 1.60 | 0.56 | 0.89 | 0.130 | 0.0 |
| Alloy M | 24.88 | 6.42 | 31.30 | 0.04 | Bal. | 0.70 | 0.25 | 1.60 | 0.56 | 0.89 | 0.150 | 0.0 |
| Alloy N | 24.88 | 6.42 | 31.30 | 0.04 | Bal. | 0.70 | 0.25 | 1.60 | 0.56 | 0.89 | 0.200 | 0.0 |

TABLE 12

| Sub | Alloy composition (mass %) | | | | | | | | | | |
|---|---|---|---|---|---|---|---|---|---|---|---|
| alloy | Nd | Pr | TRE | Al | Fe | Ga | Cu | Co | Zr | B | C |
| Alloy j | 24.88 | 6.42 | 31.30 | 0.04 | Bal. | 0.00 | 0.06 | 5.10 | 0.00 | 0.00 | 0.010 |
| Alloy k | 24.88 | 6.42 | 31.30 | 0.04 | Bal. | 0.00 | 0.06 | 5.10 | 3.00 | 0.00 | 0.010 |
| Alloy l | 24.88 | 6.42 | 31.30 | 0.04 | Bal. | 0.00 | 0.06 | 5.10 | 5.33 | 0.00 | 0.010 |
| Alloy m | 24.88 | 6.42 | 31.30 | 0.04 | Bal. | 0.00 | 0.06 | 5.10 | 7.00 | 0.00 | 0.010 |
| Alloy n | 24.88 | 6.42 | 31.30 | 0.04 | Bal. | 0.00 | 0.06 | 5.10 | 10.00 | 0.00 | 0.010 |

TABLE 13

| | Alloy composition (mass %) | | | | | | | | | | |
|---|---|---|---|---|---|---|---|---|---|---|---|
| Alloy | Nd | Pr | TRE | Al | Fe | Ga | Cu | Co | Zr | B | C |
| Alloy β | 24.88 | 6.42 | 31.30 | 0.04 | Bal | 0.63 | 0.23 | 1.95 | 1.04 | 0.80 | 0.118 |

TABLE 14

| | Exam- | | | Mix | | | | | | | | | | | | | |
|---|---|---|---|---|---|---|---|---|---|---|---|---|---|---|---|---|---|
| | ple/ | | | ratio | Sin- | | | | | | | | | | | | C at- |
| Sam- | Compar- | | | (based | tering | | | | | | | | | | | | tributed |
| ple | ative | Main | Sub | on | time | Magnet composition (mass %) | | | | | | | | | | | to alloy |
| No. | Example | alloy | alloy | mass) | (h) | Nd | Pr | TRE | Al | Fe | Ga | Cu | Co | Zr | B | C | (mass %) |
| 19 | Compar- | Alloy J | Alloy l | 90:10 | 4 | 24.88 | 6.42 | 31.30 | 0.04 | Bal. | 0.63 | 0.23 | 1.95 | 1.04 | 0.80 | 0.140 | 0.055 |
| | ative | | | | | | | | | | | | | | | | |
| | Example | | | | | | | | | | | | | | | | |
| 20 | Example | Alloy K | Alloy l | 90:10 | 4 | 24.88 | 6.42 | 31.30 | 0.04 | Bal. | 0.63 | 0.23 | 1.95 | 1.04 | 0.80 | 0.167 | 0.082 |
| 21 | Example | Alloy L | Alloy l | 90:10 | 4 | 24.88 | 6.42 | 31.30 | 0.04 | Bal. | 0.63 | 0.23 | 1.95 | 1.04 | 0.80 | 0.203 | 0.118 |
| 22 | Example | Alloy M | Alloy l | 90:10 | 4 | 24.88 | 6.42 | 31.30 | 0.04 | Bal. | 0.63 | 0.23 | 1.95 | 1.04 | 0.80 | 0.221 | 0.136 |
| 23 | Compar- | Alloy N | Alloy l | 90:10 | 4 | 24.88 | 6.42 | 31.30 | 0.04 | Bal. | 0.63 | 0.23 | 1.95 | 1.04 | 0.80 | 0.266 | 0.181 |
| | ative | | | | | | | | | | | | | | | | |
| | Example | | | | | | | | | | | | | | | | |
| 24 | Compar- | Alloy L | Alloy j | 90:10 | 4 | 24.88 | 6.42 | 31.30 | 0.04 | Bal. | 0.63 | 0.23 | 1.95 | 0.50 | 0.80 | 0.203 | 0.118 |
| | ative | | | | | | | | | | | | | | | | |
| | Example | | | | | | | | | | | | | | | | |
| 25 | Example | Alloy L | Alloy k | 90:10 | 4 | 24.88 | 6.42 | 31.30 | 0.04 | Bal. | 0.63 | 0.23 | 1.95 | 0.80 | 0.80 | 0.203 | 0.118 |
| 21 | Example | Alloy L | Alloy l | 90:10 | 4 | 24.88 | 6.42 | 31.30 | 0.04 | Bal. | 0.63 | 0.23 | 1.95 | 1.04 | 0.80 | 0.203 | 0.118 |
| 26 | Example | Alloy L | Alloy m | 90:10 | 4 | 24.88 | 6.42 | 31.30 | 0.04 | Bal. | 0.63 | 0.23 | 1.95 | 1.20 | 0.80 | 0.203 | 0.118 |
| 27 | Compar- | Alloy L | Alloy n | 90:10 | 4 | 24.88 | 6.42 | 31.30 | 0.04 | Bal. | 0.63 | 0.23 | 1.95 | 1.50 | 0.80 | 0.203 | 0.118 |
| | ative | | | | | | | | | | | | | | | | |
| | Example | | | | | | | | | | | | | | | | |

| | | | | | | | | | | | | | | | |
|---|---|---|---|---|---|---|---|---|---|---|---|---|---|---|---|
| 28 | Compar- | Alloy β only | 4 | 24.88 | 6.42 | 31.30 | 0.04 | Bal. | 0.63 | 0.23 | 1.95 | 1.04 | 0.80 | 0.203 | 0.118 |
| | ative | | | | | | | | | | | | | | |
| | Example | | | | | | | | | | | | | | |

TABLE 15

| | | | | | | Zr | | | |
|---|---|---|---|---|---|---|---|---|---|
| | | | | | | compound | | | |
| | Example/ | | | | S(C)/ | max | | | |
| Sample | Comparative | [Zr1] | [Zr2] | [Zr1]/ | (S(B)+S(C)) | grain size | Br | HcJ | Hk/HcJ |
| No. | Example | (at %) | (at %) | [Zr2] | (%) | (μm) | (mT) | (kA/m) | (%) |
| 19 | Comparative | 0.09 | 0.07 | 1.29 | 80.0 | 0.5 | 1331 | 1560 | 71.1 |
| | Example | | | | | | | | |
| 20 | Example | 0.07 | 0.07 | 1.00 | 100 | 0.5 | 1368 | 1751 | 96.6 |
| 21 | Example | 0.07 | 0.07 | 1.00 | 100 | 0.5 | 1372 | 1741 | 98.2 |
| 22 | Example | 0.07 | 0.08 | 0.88 | 100 | 0.5 | 1375 | 1740 | 98.2 |
| 23 | Comparative | 0.07 | 0.08 | 0.88 | 100 | 0.5 | 1382 | 1670 | 98.2 |
| | Example | | | | | | | | |
| 24 | Comparative | 0.06 | 0.04 | 1.50 | 100 | 0.5 | 1375 | 1702 | 91.3 |
| | Example | | | | | | | | |
| 25 | Example | 0.07 | 0.07 | 1.00 | 100 | 0.5 | 1381 | 1733 | 98.4 |
| 21 | Example | 0.07 | 0.07 | 1.00 | 100 | 0.5 | 1372 | 1741 | 98.2 |
| 26 | Example | 0.08 | 0.09 | 0.89 | 100 | 0.5 | 1362 | 1743 | 97.6 |
| 27 | Comparative | 0.10 | 0.12 | 0.83 | 97.7 | 0.5 | 1349 | 1732 | 90.5 |
| | Example | | | | | | | | |
| 28 | Comparative | 0.42 | 0.10 | 4.20 | 100 | 0.5 | 1371 | 1533 | 65.7 |
| | Example | | | | | | | | |

The R-T-B based permanent magnet of each Example had good Br, good HcJ, and good Hk/HcJ.

Sample No. 19 had too low a carbon content of the main alloy. As a result, S(C)/(S(B)+S(C)) was too low; and Br, HcJ, and Hk/HcJ decreased.

Sample No. 23 had too high a carbon content of the main alloy. As a result, the R-T-B based permanent magnet eventually manufactured had too high a carbon content and had a decreased HcJ.

Sample No. 24 had too low a Zr content of the sub alloy. As a result, HcJ and Hk/HcJ decreased. It was assumed that the decrease in HcJ and Hk/HcJ was because of abnormal grain growth of the main phase grains.

Sample No. 27 had too high a Zr content of the sub alloy. As a result, S(C)/(S(B)+S(C)) was too low; and Br and Hk/HcJ decreased.

In Sample No. 28, which had the same composition as Sample No. 21 but was manufactured using a one-alloy method, [Zr1] was too high, and [Zr1]/[Zr2] was too high. As a result, HcJ and Hk/HcJ decreased.

### Experiment 5

Experiment 5 was conducted as in Sample No. 21 except that the sintering time varied. Table 16 shows the results.

TABLE 16

| | | | | | | | Zr | | | |
|---|---|---|---|---|---|---|---|---|---|---|
| | | | | | | | compound | | | |
| | Example/ | Sintering | | | | S(C)/ | max | | | |
| Sample | Comparative | time | [Zr1] | [Zr2] | [Zr1]/ | (S(B)+S(C)) | grain size | Br | HcJ | Hk/HcJ |
| No. | Example | (h) | (at %) | (at %) | [Zr2] | (%) | (μm) | (mT) | (kA/m) | (%) |
| 29 | Example | 1 | 0.10 | 0.13 | 0.77 | 100 | 0.5 | 1371 | 1733 | 96.3 |
| 30 | Example | 2 | 0.07 | 0.10 | 0.70 | 100 | 0.5 | 1373 | 1741 | 97.1 |
| 21 | Example | 4 | 0.07 | 0.07 | 1.00 | 100 | 0.5 | 1372 | 1741 | 98.2 |
| 31 | Example | 8 | 0.06 | 0.06 | 1.00 | 100 | 0.5 | 1372 | 1751 | 98.1 |
| 32 | Example | 10 | 0.06 | 0.06 | 1.00 | 100 | 0.5 | 1372 | 1744 | 98.0 |

Even with varied sintering time, each Example having [Zr1], [Zr1]/[Zr2], and S(C)/(S (B)+S(C)) within the predetermined ranges had good Br, good HcJ, and good Hk/HcJ.

### Experiment 6

Sample Nos. 34 and 35 were manufactured, each of which had a mix ratio (the main alloy: the sub alloy) varying from that of Sample No. 21 and had compositions of the main alloy and the sub alloy varying from those of Sample No. 21 so that the R-T-B based permanent magnet eventually manufactured had substantially the same composition as Sample No. 21. Tables 17 to 20 show the results.

TABLE 17

| | | | | | | | | | | | | Area |
|---|---|---|---|---|---|---|---|---|---|---|---|---|
| | | | | | | | | | | | | percentage |
| | | | | | | | | | | | | of 6-13-1 |
| Main | Alloy composition (mass %) | | | | | | | | | | | phase |
| alloy | Nd | Pr | TRE | Al | Fe | Ga | Cu | Co | Zr | B | C | (%) |
| Alloy P | 24.88 | 6.42 | 31.30 | 0.04 | Bal. | 0.74 | 0.26 | 1.40 | 0.56 | 0.94 | 0.138 | 0.0 |
| Alloy L | 24.88 | 6.42 | 31.30 | 0.04 | Bal. | 0.70 | 0.25 | 1.60 | 0.56 | 0.89 | 0.130 | 0.0 |
| Alloy Q | 24.88 | 6.42 | 31.30 | 0.04 | Bal. | 0.86 | 0.32 | 1.68 | 0.56 | 0.87 | 0.128 | 0.0 |

TABLE 18

| Sub | Alloy composition (mass %) | | | | | | | | | | |
|---|---|---|---|---|---|---|---|---|---|---|---|
| alloy | Nd | Pr | TRE | Al | Fe | Ga | Cu | Co | Zr | B | C |
| Alloy p | 24.88 | 6.42 | 31.30 | 0.04 | Bal. | 0.00 | 0.06 | 5.10 | 4.00 | 0.00 | 0.010 |
| Alloy l | 24.88 | 6.42 | 31.30 | 0.04 | Bal. | 0.00 | 0.06 | 5.10 | 5.33 | 0.00 | 0.010 |
| Alloy q | 24.88 | 6.42 | 31.30 | 0.04 | Bal. | 0.00 | 0.06 | 5.10 | 7.00 | 0.00 | 0.010 |

TABLE 19

| | Example/ | | | Mix | Sin- | | | | | | | | | | | | C at- |
|---|---|---|---|---|---|---|---|---|---|---|---|---|---|---|---|---|---|
| Sam- | Compar- | | | ratio | tering | | | | | | | | | | | | tributed |
| ple | ative | Main | Sub | (based | time | Magnet composition (mass %) | | | | | | | | | | | to alloy |
| No. | Example | alloy | alloy | on mass) | (h) | Nd | Pr | TRE | Al | Fe | Ga | Cu | Co | Zr | B | C | (mass %) |
| 34 | Example | Alloy P | Alloy g | 85:15 | 4 | 24.884 | 6.417 | 31.30 | 0.04 | Bal. | 0.63 | 0.23 | 1.96 | 1.08 | 0.80 | 0.203 | 0.118 |
| 21 | Example | Alloy L | Alloy l | 90:10 | 4 | 24.884 | 6.417 | 31.30 | 0.04 | Bal. | 0.63 | 0.23 | 1.95 | 1.04 | 0.80 | 0.203 | 0.118 |
| 35 | Example | Alloy Q | Alloy h | 92:8 | 4 | 24.884 | 6.417 | 31.30 | 0.04 | Bal. | 0.79 | 0.30 | 1.95 | 1.08 | 0.80 | 0.203 | 0.118 |

TABLE 20

| | | | | | | Zr | | | |
|---|---|---|---|---|---|---|---|---|---|
| | | | | | | compound | | | |
| | Example/ | | | | S(C)/ | max | | | |
| Sample | Comparative | [Zr1] | [Zr2] | [Zr1]/ | (S(B) + S(C)) | grain size | Br | HcJ | Hk/HcJ |
| No. | Example | (at %) | (at %) | [Zr2] | (%) | (μm) | (mT) | (kA/m) | (%) |
| 34 | Example | 0.08 | 0.10 | 0.80 | 100 | 0.5 | 1371 | 1739 | 96.9 |
| 21 | Example | 0.07 | 0.07 | 1.00 | 100 | 0.5 | 1372 | 1741 | 98.2 |
| 35 | Example | 0.07 | 0.09 | 0.78 | 100 | 0.5 | 1372 | 1732 | 96.1 |

Even with varied mix ratios, each Example having [Zr1], [Zr1]/[Zr2], and S(C)/(S(B)+S(C)) within the predetermined ranges had good Br, good HcJ, and good Hk/HcJ.

### REFERENCE NUMERALS

1, 2 . . . . R-T-B based permanent magnet
11 . . . main phase grain
13 . . . grain boundary
13a . . . . R-containing portion
13b . . . . Zr-containing portion
15 . . . . Zr compound

What is claimed is:

1. An R-T-B based permanent magnet comprising C and Zr, wherein
the R-T-B based permanent magnet comprises a main phase grain and a grain boundary;
the R-T-B based permanent magnet has
a [Zr1] of 0 or more and 0.35 at % or less, where [Zr1] denotes a Zr concentration of a center portion of the main phase grain, and
a S(C)/(S(B)+S(C)) of 98.0% or more, where S(B) denotes a total area of ZrB₂ in the grain boundary and S(C) denotes a total area of ZrC in the grain boundary,
in a section of the R-T-B based permanent magnet; and
the R-T-B based permanent magnet has
a Zr content of 0.60 mass % or more and 1.60 mass % or less,
a B content of above 0 mass % and 0.85 mass % or less, and
a C content of above 0 mass % and 0.260 mass % or less,
out of 100 mass % of the R-T-B based permanent magnet.

2. The R-T-B based permanent magnet according to claim 1, wherein a total area percentage of ZrB₂ in the section of the R-T-B based permanent magnet is 0% or more and less than 0.01%.

3. The R-T-B based permanent magnet according to claim 1, wherein
ZrB₂ has a maximum grain size of 1.0 μm or less; and
ZrC has a maximum grain size of 1.0 μm or less.

4. The R-T-B based permanent magnet according to claim 1 having a heavy rare earth element content of 0 mass % or more and 0.80 mass % or less.

5. The R-T-B based permanent magnet according to claim 1 further comprising Ga and having a Ga content of 0.40 mass % or more and 1.00 mass % or less.

6. The R-T-B based permanent magnet according to claim 1 further comprising Al and having an Al content of above 0 mass % and 0.07 mass % or less.

7. The R-T-B based permanent magnet according to claim 1 having a rare earth element content of 29.00 mass % or more and 34.00 mass % or less.

8. The R-T-B based permanent magnet according to claim 1 having a rare earth element content of 30.00 mass % or more and 33.00 mass % or less and a B content of 0.70 mass % or more and 0.85 mass % or less.

9. An R-T-B based permanent magnet comprising C and Zr, wherein
the R-T-B based permanent magnet comprises a main phase grain and a grain boundary;
the R-T-B based permanent magnet has
a [Zr1]/[Zr2] of 0.70 or more and 1.20 or less in atomic ratio, where [Zr1] denotes a Zr concentration of a center portion of the main phase grain and [Zr2] denotes a Zr concentration of a peripheral portion of the main phase grain, and
a S(C)/(S(B)+S(C)) of 98.0% or more, where S(B) denotes a total area of ZrB₂ in the grain boundary and S(C) denotes a total area of ZrC in the grain boundary,
in a section of the R-T-B based permanent magnet; and
the R-T-B based permanent magnet has
a Zr content of 0.60 mass % or more and 1.60 mass % or less,
a B content of above 0 mass % and 0.85 mass % or less, and
a C content of above 0 mass % and 0.260 mass % or less,
out of 100 mass % of the R-T-B based permanent magnet.

10. The R-T-B based permanent magnet according to claim 9, wherein a total area percentage of ZrB₂ in the section of the R-T-B based permanent magnet is 0% or more and less than 0.01%.

11. The R-T-B based permanent magnet according to claim 9, wherein
ZrB₂ has a maximum grain size of 1.0 μm or less; and
ZrC has a maximum grain size of 1.0 μm or less.

12. The R-T-B based permanent magnet according to claim 9 having a heavy rare earth element content of 0 mass % or more and 0.80 mass % or less.

13. The R-T-B based permanent magnet according to claim 9 further comprising Ga and having a Ga content of 0.40 mass % or more and 1.00 mass % or less.

14. The R-T-B based permanent magnet according to claim 9 further comprising Al and having an Al content of above 0 mass % and 0.07 mass % or less.

15. The R-T-B based permanent magnet according to claim 9 having a rare earth element content of 29.00 mass % or more and 34.00 mass % or less.

16. The R-T-B based permanent magnet according to claim 9 having a rare earth element content of 30.00 mass % or more and 33.00 mass % or less and a B content of 0.70 mass % or more and 0.85 mass % or less.

17. A method of manufacturing an R-T-B based permanent magnet, comprising:
preparing a main alloy and a sub alloy; and
mixing the main alloy and the sub alloy,
wherein
the main alloy has a C content of 0.070 mass % or more and 0.180 mass % or less;
the sub alloy has a Zr content of 3.00 mass % or more and 7.00 mass % or less; and
the main alloy and the sub alloy are mixed at a ratio of 85:15 to 92:8 based on mass.

18. The method according to claim 17, wherein
the main alloy has
a rare earth element content of 30.00 mass % or more and 32.50 mass % or less,
an Al content of 0 mass % or more and 0.10 mass % or less,
a Ga content of 0.40 mass % or more and 1.20 mass % or less,
a Cu content of 0.10 mass % or more and 1.00 mass % or less,
a Co content of 0.50 mass % or more and 3.00 mass % or less,
a Zr content of 0.10 mass % or more and 0.80 mass % or less, and
a B content of 0.70 mass % or more and 1.00 mass % or less; and
the sub alloy has
a rare earth element content of 30.00 mass % or more and 45.00 mass % or less,
an Al content of 0 mass % or more and 1.00 mass % or less,
a Ga content of 0 mass % or more and 8.00 mass % or less,
a Cu content of 0 mass % or more and 5.00 mass % or less, and
a Co content of 0 mass % or more and 10.00 mass % or less.

19. The method according to claim 17, wherein an area percentage of a 6-13-1 phase in a section of the main alloy is 0% or more and less than 2.0%.

20. The method according to claim 17 further comprising sintering a green compact for a sintering time of 2 hours or more and 8 hours or less.

21. The method according to claim 17, wherein the R-T-B based permanent magnet has
a rare earth element content of 30.00 mass % or more and 33.00 mass % or less,
a B content of 0.70 mass % or more and 0.88 mass % or less,
an Al content of above 0 mass % and 0.07 mass % or less,
a Ga content of 0.40 mass % or more and 1.00 mass % or less, and
a Zr content of above 0.10 mass % and 1.60 mass % or less.
